(19) United States
(12) Patent Application Publication
(10) Pub. No.: US 2006/0092770 A1
(43) Pub. Date: May 4, 2006

(54) Information displays and methods associated therewith

(76) Inventor: Theodore James Demas, Aspen, CO (US)

Correspondence Address: LATHROP & GAGE LC, 4845 PEARL EAST CIRCLE, SUITE 300, BOULDER, CO, 80301, US

(21) Appl. No.: 11/071,269

(22) Filed: Mar. 3, 2005

Related U.S. Application Data
(63) Continuation-in-part of application No. 10/978,066, filed on Oct. 30, 2004.

(51) Int. Cl. G04B 25/00; G04C 17/00

(52) U.S. Cl. 368/223

(57) ABSTRACT

In one embodiment, an information display includes timing elements arranged in a circle about a center, the timing elements overlapping each other, and other elements arranged in a second circle around the first circle. The information display has an hour hand, a minute hand and, optionally, a third hand, each hand having one or more encircling elements to indicate time. Another information display includes overlapping elements, with some elements having a first appearance, and other elements having a second appearance, so that the elements indicate a value within a predetermined range. In another embodiment, an information display includes a plurality of overlapping display elements, wherein certain of the elements change in appearance to indicate the time. A method of setting a time in a clock display having timing elements is also provided, in other embodiments. Other embodiments include software products generating information displays and, for example, methods to indicate time.

### RELATED APPLICATIONS

This application is a continuation-in-part of U.S. patent application Ser. No. 10/978,066, filed 30 Oct. 2004 and incorporated herein by reference.

### BACKGROUND

Information displays may take a variety of forms. For example, a traditional analog clock face uses a small hour hand, a larger minute hand, and, optionally, a thinner hand pivoting about a center; these hands point towards positions around a periphery of the clock to indicate hours, minutes and, optionally, seconds of current time. Numerals and/or tick marks optionally serve as visual references to help a viewer determine the position of the hands. While widely used, the traditional analog clock face is not easily understood at an intuitive level. For example, some children find it difficult to learn because (a) the hour hand carries the most significant information, and yet is the smallest of the hands, (b) the minute hand may periodically obstruct visibility of the hour hand, making hour of day hard to determine, and (c) when an hour hand is in a position between two hours, a child may be confused as to which hour of day is indicated. Other information displays may generate confusion and/or ambiguity in a similar manner to (a), (b) and (c) above.

### SUMMARY

In one embodiment, an information display has at least twenty-four timing elements. A first twelve of the timing elements are arranged in a first circle about a center; each of the first twelve elements overlaps another of the first twelve elements and is overlapped by another of the first twelve elements. A second twelve of the timing elements are arranged in a second circle that is larger than the first circle. Each of the second twelve elements is tangential to one of the first twelve elements. An hour hand has a first encircling element that positions over one of the first twelve timing elements to indicate an hour. A minute hand has a second encircling element that positions over one of the second twelve timing elements, to indicate a five minute increment.

In another embodiment, an information display has twelve timing elements arranged in a first circle about a center. Each of the first twelve timing elements overlaps another of the first twelve timing elements and is overlapped by another of the first twelve timing elements. Sixty timing elements are arranged in a plurality of groups; each of groups has two, three, four, five, six, ten, fifteen, twenty or thirty timing elements disposed in a spiral pattern. Each of the sixty timing elements is located at a six degree angular offset, relative to the center, from two other of the sixty timing elements. An hour hand has a first encircling element that positions over one of the twelve timing elements, to indicate an hour, and a minute hand has a second encircling element that positions over one of the sixty timing elements, to indicate a minute.

In another embodiment, a calendar display has twelve month timing elements and thirty-one day-of-month timing elements. A month hand has a first encircling element that is positionable over each one of the month timing elements, to indicate a month. A day-of-month hand has a second encircling element that is positionable over each one of the day-of-month timing elements, to indicate a day of a month.

In one embodiment, a software product has instructions, stored on computer-readable media, wherein the instructions, when executed by a processor, perform steps for showing time, the instructions including: instructions for forming at least twenty-four timing elements, a first twelve of the timing elements being arranged in a first circle about a center, each of the first twelve elements overlapping another of the first twelve elements and being overlapped by another of the first twelve elements, a second twelve of the timing elements being arranged in a second circle, the second circle being larger than the first circle, each of the second twelve elements being tangential to one of the first twelve elements; instructions for forming an hour hand having a first encircling element that positions over one of the first twelve timing elements, to indicate an hour; and instructions for forming a minute hand having a second encircling element that positions over one of the second twelve timing elements, to indicate a five minute increment.

In one embodiment, an information display comprises timing elements and two or more hands, at least one of the hands comprising an encircling element, wherein the information display indicates time by positioning the encircling element over one of the timing elements.

In one embodiment, a software product has instructions, stored on computer-readable media, wherein the instructions, when executed by a processor, perform steps for setting time of a clock display, the instructions including: instructions for activating individual display devices of an array of display devices to form a plurality of timing elements, each of the timing elements corresponding to a time value; and instructions for responding to a pointing device that points to one of the timing elements to set time of the clock display.

In one embodiment, a method sets a time in a clock display having timing elements, including: activating individual display devices of an array of display devices to form a plurality of timing elements, each of the timing elements corresponding to a time value; and responding to a pointing device that points to one of the timing elements to set time of the clock display.

In one embodiment, a speedometer display has a plurality of display elements forming coarse speed elements and arranged in a first arc such that, except display elements at ends of the first arc, each coarse speed element overlaps another of the display elements and is overlapped by another of the display elements; a plurality of display elements forming fine speed elements and arranged in a second arc that is adjacent to the first arc; and a pivoting pointing element having an encircling element, for indicating a coarse speed number by pivoting the encircling element over one of the coarse speed elements.

### BRIEF DESCRIPTION OF THE DRAWINGS

FIG. 1 shows an information display in accord with an embodiment.

FIG. 2 shows an information display in accord with an embodiment.

FIG. 3 shows an information display in accord with an embodiment.

FIG. 3A shows the information display of FIG. 3 indicating a specific time.

FIG. 3B shows an information display in the form of a clock display illustratively indicating a time.

FIG. 4 shows an information display in accord with an embodiment.

FIG. 5 shows an information display in accord with an embodiment.

FIG. 5A is an enlarged view of area A of FIG. 5.

FIG. 5B is an enlarged view of area B of FIG. 5A.

FIG. 6 shows an information display in accord with an embodiment.

FIG. 7 shows an information display in accord with an embodiment.

FIG. 8 shows an information display in accord with an embodiment.

FIG. 9 shows an information display in accord with an embodiment.

FIG. 10 shows an information display in accord with an embodiment.

FIG. 11 shows an information display in accord with an embodiment.

FIG. 12 shows an information display in accord with an embodiment.

FIG. 13 shows an information display in accord with one embodiment.

FIG. 14 shows a portion of an information display.

FIG. 15 shows a portion of an information display.

FIG. 16 shows a portion of an information display.

FIG. 17 shows an information display in accord with one embodiment.

FIG. 17A shows details of the hour hand, the minute hand and the third hand of the information display of FIG. 17.

FIG. 18 shows an information display in accord with an embodiment.

FIG. 19 shows an information display in accord with an embodiment.

FIG. 20 shows a user interface including an information display in accord with an embodiment.

FIG. 21 shows a timekeeping mechanism used to drive an information display in accord with an embodiment.

FIG. 22 is a schematic diagram illustrating a power source, a clock circuit, a processor and a user interface, for use with an information display, in accord with an embodiment.

FIG. 23A and FIG. 23B show exemplary information displays during a time input process, in accord with an embodiment.

FIG. 24 is a flowchart of a process embodiment to update an information display.

### DETAILED DESCRIPTION OF THE DRAWINGS

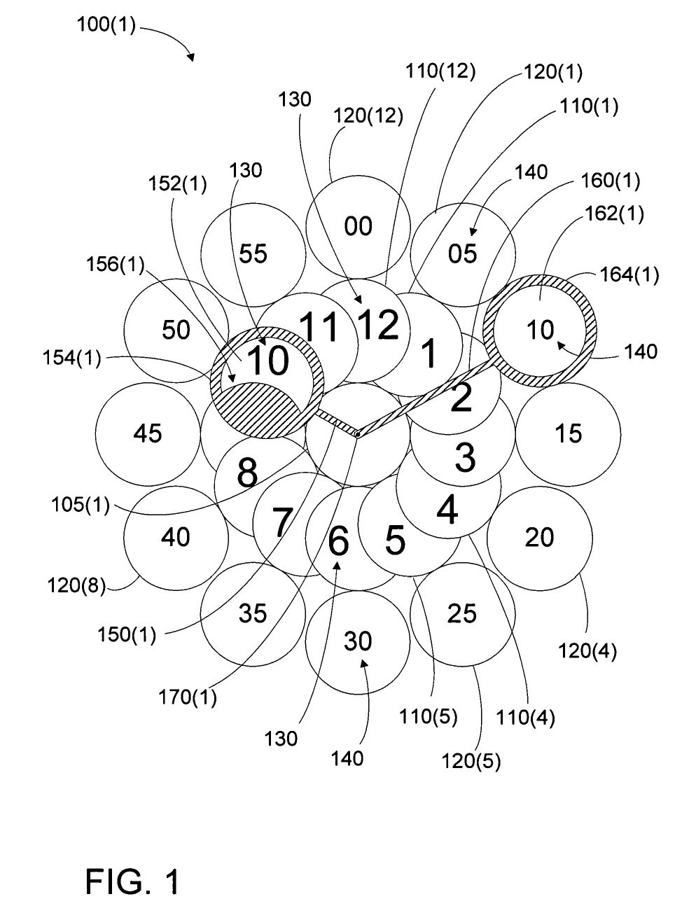

Information displays described below include, for example, clock and calendar displays. FIG. 1 shows an information display in the form of a clock display 100(1). Clock display 100(1) includes a central circular timing element 105(1), circular timing elements 110(l)-1 10(12), circular timing elements 120(1)-120(12), and an hour hand 150(1) and a minute hand 160(1) that rotate about a center 170(1). Circular timing elements 110(1)-1 10(12) are circles that are tangential to, and the same size as, central circular timing element 105(1); each of elements 110(1)-110(12) overlaps an adjacent element 110(1)-110(12) to form a ring, and a numeral 130 is associated with each element 110, as shown. Circular timing elements 120(1)-120(12) are circles that are tangential to, and the same size as, elements 110(1)-110(12); a numeral 140 is also associated with each element 120(1)-120(12), as shown.

Hour hand 150(1) of display 100(1) has an encircling element 154(1) that forms an aperture 152(1). Aperture 152(1) may position over one of elements 110(1)-110(12) to indicate an hour; for example, FIG. 1 shows hour hand 150(1) with aperture 152(1) over element 110(10), indicating a time that includes ten o'clock. In the embodiment of FIG. 1, a blocking portion 156(1) of hour hand 150(1) provides a symmetrical appearance to hour hand 150(1) since it adjoins encircling element 154(1) to form a circle while at the same time blocking the overlapping portion of an adjacent element 110; for example, FIG. 1 shows blocking portion 156(1) over part of element 110(9). Encircling element 154(1) may facilitate the recognition of a time indicated by hour hand 150(1) because it unambiguously encircles an indicated hour rather than pointing in the general direction of the hour.

Minute hand 160(1) of display 100(1) has an encircling element 164(1) that forms an aperture 162(1); aperture 162(1) may position over one of elements 120(12) to indicate minutes of an hour.

Hour hand 150(1) and minute hand 160(1) move in discrete steps about center 170(1), each step corresponding to a time increment. The mechanism to drive these incremental steps may for example comprise U.S. Pat. No. 3,712,048, incorporated herein by reference. Each incremental step of hour hand 150(1) indicates a time increment of one hour; each incremental step of minute hand 160(1) indicates a time increment of five minutes. Thus, the position of minute hand 160(1) in FIG. 1, with aperture 162(1) over element 120(2), indicates a time increment beginning at ten minutes past an hour and ending at, but not including, fifteen minutes past an hour.

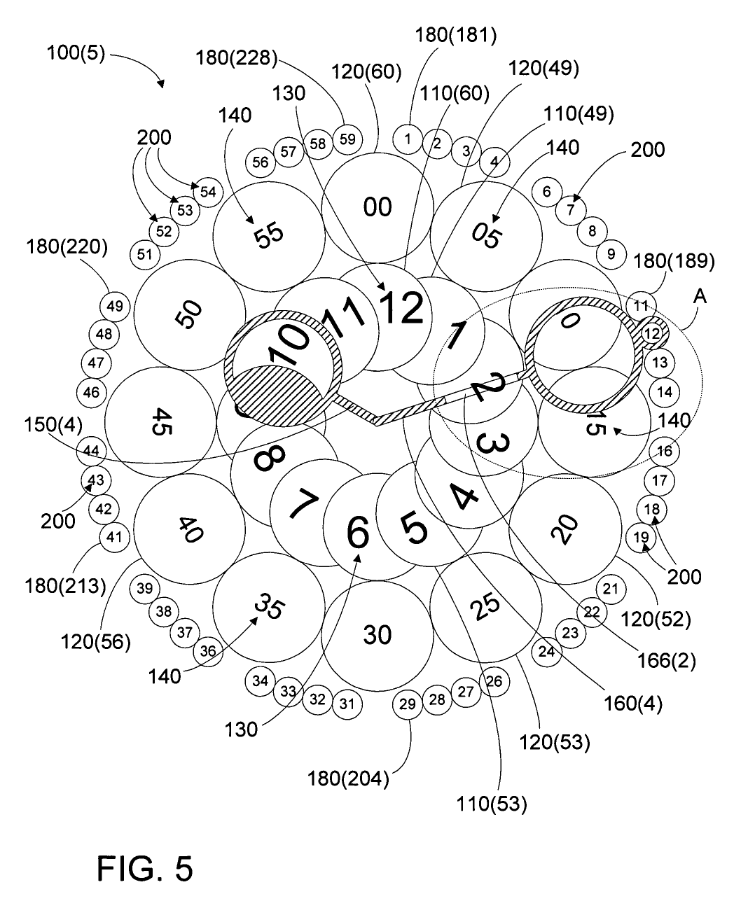

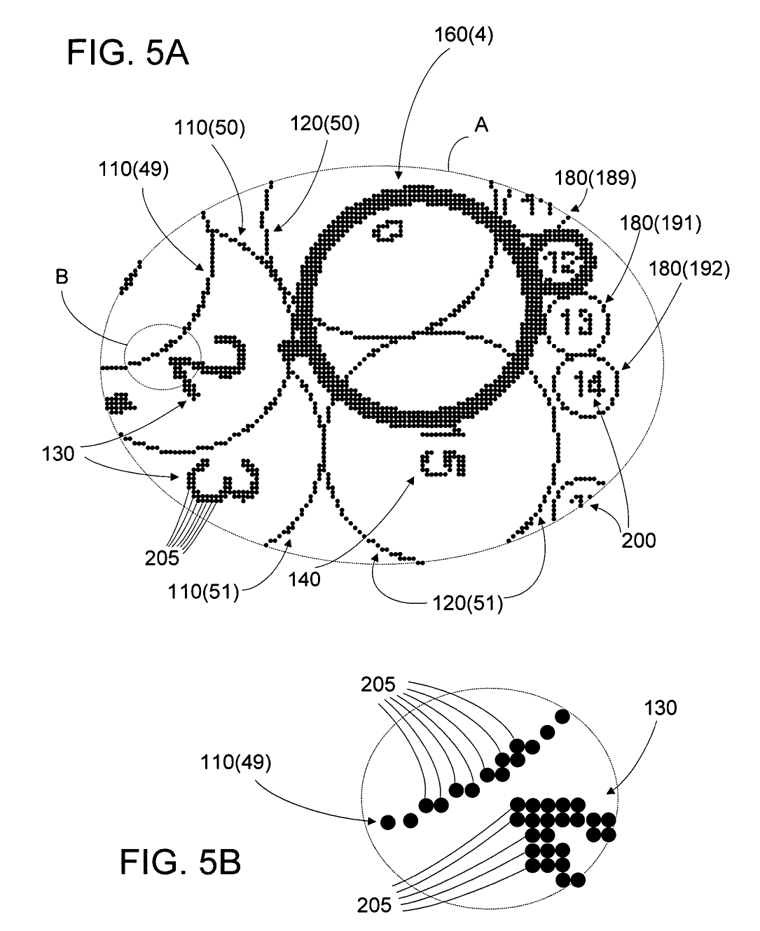

Elements 110(1)-110(12), 120(1)-120(12) and numerals 130, 140 may be formed by electronic display devices (e.g., liquid crystal displays (LCDs), light-emitting devices (e.g., discrete lamps or light emitting diodes (LEDs)) and/or structure (e.g., metal, plastic, glass, ceramic). Hands 150(1) and 160(1) may be “virtual,” formed by selective activation of electronic display devices or light emitting devices; alternatively they may be structural elements (e.g., formed of metal, plastic, glass, and/or ceramic) that are driven around center 170(1) by a timekeeping mechanism. In one embodiment, each of the elements, hands and numerals is formed, at least in part, by activated display devices within an array of display devices, as described in connection with FIG. 5A.

Numerals 130 and 140 in clock display 100(1) are examples of indicia (e.g., printed, embossed, displayed) which may help a viewer determine an hour, minute and/or second indicated by hands (e.g., hands 150(1) and/or 160(1)).

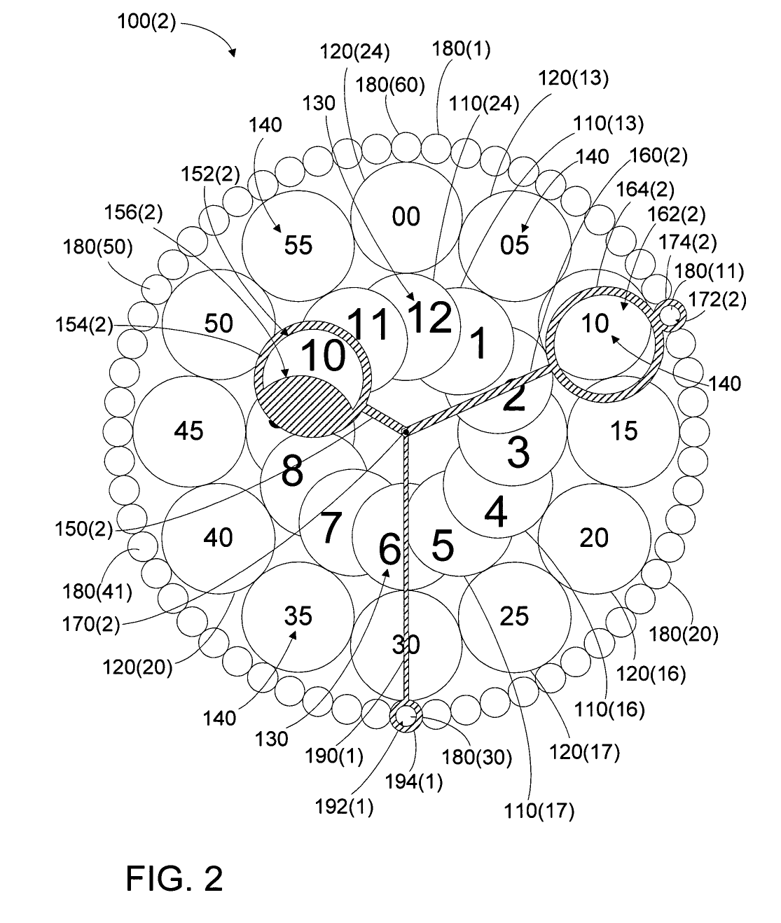

As now described, certain embodiments of information displays may include hands that move in different discrete steps (as compared to the incremental steps illustrated in FIG. 1) and/or that move in continuous motions. FIG. 2 shows an information display in the form of a clock display 100(2). Clock display 100(2) has circular timing elements 1 10(13)-110(24), circular timing elements 120(13)-120(24), and an hour hand 150(2) that are similar to circular timing elements 110(1)-110(12), circular timing elements 120(1)-120(12) and hour hand 150(1), respectively, of clock display 100(1). Circular timing elements 120(13)-120(24) of clock display 100(2) are larger than circular timing elements 110(13)-110(24); consequently each of elements 120(13)-120(24) is tangential to two adjacent elements 120(13)-120(24), unlike elements 120(1)-120(12) of clock display 100(1). Clock display 100(2) also has sixty circular timing elements 180(1)-180(60), and has a minute hand 160(2) that moves in one minute increments (as opposed to the five minute increments of minute hand 160(1)) and a third hand 190(1) to indicate seconds. Minute hand 160(2) has an encircling element 164(2) that forms an aperture 162(2), and an encircling element 174(2) that forms an aperture 172(2); third hand 190(1) has an encircling element 194(1) that forms an aperture 192(1). Numerals 130 and 140 in clock display 100(2) may help a viewer determine an hour, minute and/or second indicated by hands (e.g., hands 150(2), 160(2) and/or 190(1)).

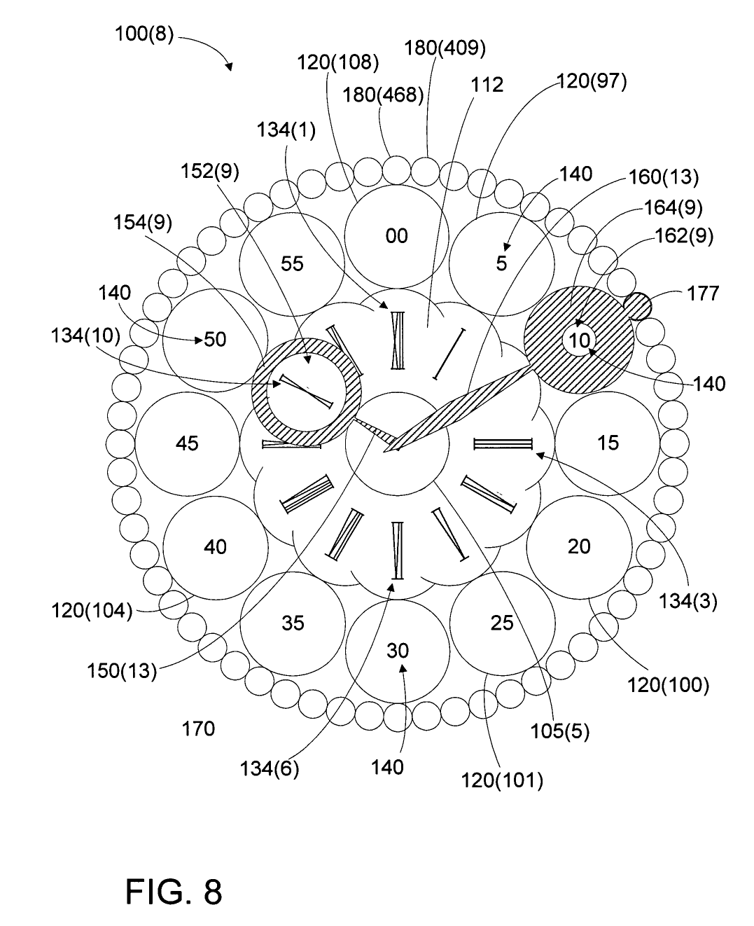

In FIG. 1, numerals are shown oriented upwards, so that they are easily read. However, these numerals may, in some embodiments, be oriented differently, such as being oriented to center 170(1) (see, e.g., FIG. 8). Moreover, numerals 130 (and like numerals below) may be oriented in one way for part of a clock display, and yet oriented in another way for another part of clock display, if so desired and without departing from the scope hereof.

Aperture 172(2) encircles one of timing elements 180(1)-180(60) to indicate a minute of an hour. For example, in FIG. 2, aperture 172(2) encircles timing element 180(11) to indicate a time of eleven minutes past an hour. Thus, aperture 162(2) positions directly over one of elements 120(13)-120(24) when displaying a time that includes a multiple of five minutes past an hour, but positions between two adjacent elements of 120(13)-120(24) when displaying a time that does not include a multiple of five minutes past an hour. Aperture 192(1) encircles one of timing elements 180(1)-180(60) to indicate seconds of a minute. For example, in FIG. 2, aperture 192(1) encircles timing element 180(30) to illustratively indicate a time of thirty seconds past a minute.

As above, elements 110(13)-110(24), 120(13)-120(24) and 180(1)-180(60) and numerals 130, 140 may be formed by electronic display devices (e.g., LCDs) and/or light-emitting devices (e.g., an array of LEDs) and/or structure (e.g., metal, plastic, glass, ceramic). Hands 150(2), 160(2) and 190(1) may be “virtual,” as above, formed by selective activation of electronic display devices or light emitting devices; or they may be structural elements (e.g., formed of metal, plastic, glass, and/or ceramic) driven around center 170(2) by a timekeeping mechanism. In one embodiment, each of the elements, hands and numerals is formed, at least in part, by an array of display devices under control of a processor, such as described in connection with FIG. 5A and FIG. 5B.

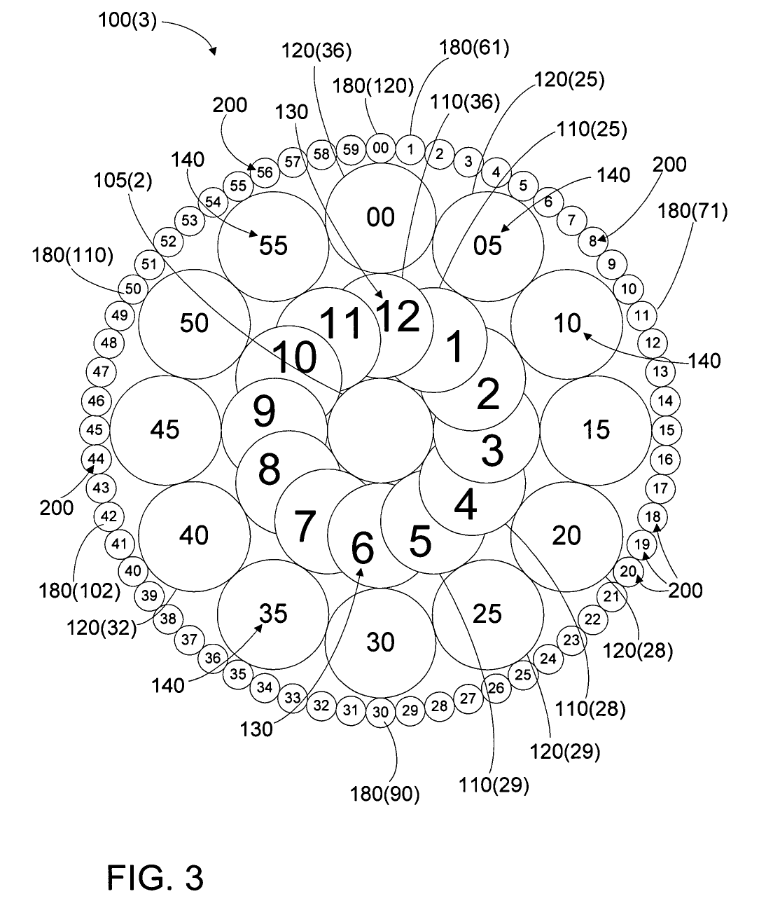

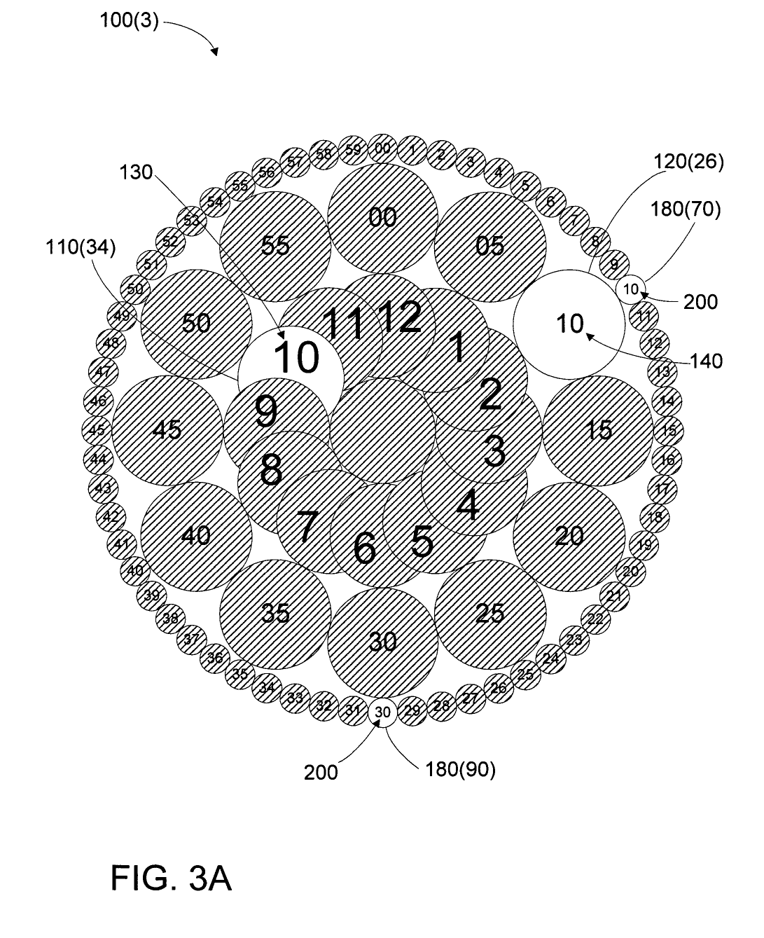

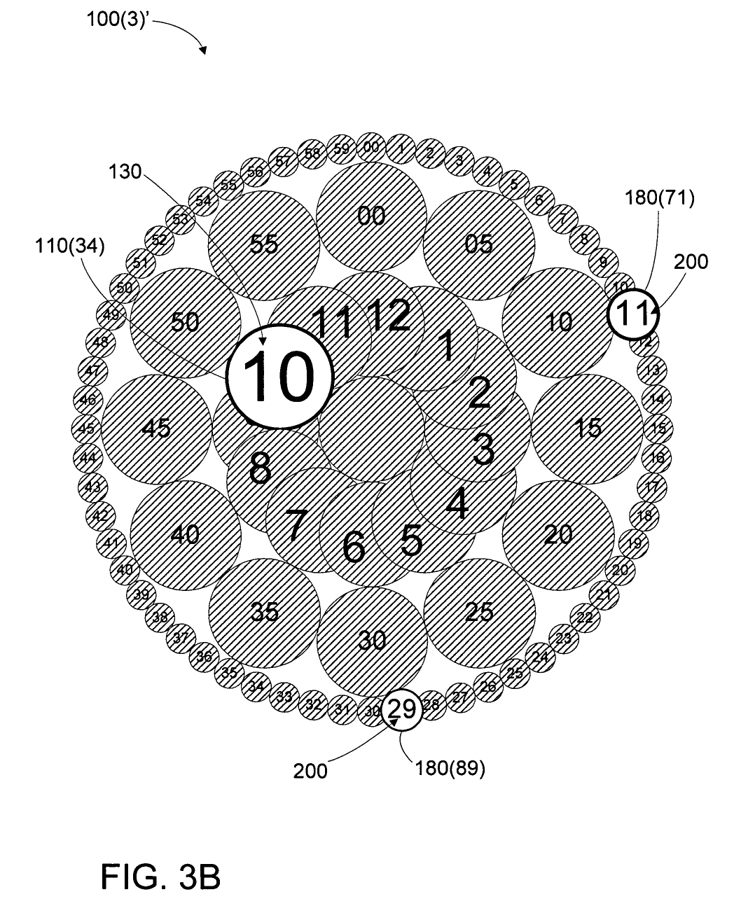

FIG. 3 shows an information display in the form of a clock display 100(3). Clock display 100(3) has a central circular timing element 105(2), circular timing elements 110(25)-110(36), circular timing elements 120(25)-120(36) and circular timing elements 180(61)-180(120). A numeral 130 is associated with each of circular timing elements 110(25)-110(36); a numeral 140 is a associated with each of circular timing elements 120(25)-120(36); and a numeral 200 is assocated with each of circular timing elements 180(61)- 180(120).

Clock display 100(3) does not utilize hands to indicate time; instead, circular timing elements 110(25)-110(36), 120(25)-120(36) and 180(61)-180(120) are controlled to display time by visually contrasting certain timing elements with other timing elements. For example, FIG. 3A illustratively indicates a time of 10:10:30 by displaying selected elements 110(34), 120(26), 180(70) and 180(90) in a first manner (e.g., by activating display elements to generate a first appearance, shown as white in FIG. 3A) and displaying all other elements 110(25)-110(36), 120(25)-120(36) and 180(61)-180(120) in a second manner (e.g., by activating display elements to generate a second appearance, shown as hatched in FIG. 3A). A viewer can tell which selected element 180 indicates minutes and which indicates seconds by viewing clock display 100(3) for more than one second; an element 180 indicating seconds will be deselected and an adjacent element 180 will be selected each second, while an element 180 indicating minutes will remain constant for a minute.

As above, elements 110(25)-110(36), 120(25)-120(36) and 180(61)-180(120) and numerals 130, 140 and 200 may be formed by electronic display devices (e.g., LCDs) and/or light-emitting devices (e.g., an array of LEDs) and structure (e.g., metal, plastic, glass, ceramic). In one embodiment, each such element is formed, at least in part, by an array of display devices under control of a processor, such as described in connection with FIG. 5A and FIG. 5B.

An information display may have elements formed by an array of display devices under control of a processor. The size, shape and characteristics of selected elements may vary; moreover, selected elements may utilize space in the information display that would otherwise be used by nonselected elements (thereby highlighting the presence of the selected elements). For example, FIG. 3B shows an information display in the form of clock display 100(3)′ illustratively indicating a time of 10:11:29. In FIG. 3B, elements 110(34), 180(71) and 180(89) are selected; these selected elements display larger numerals than non-selected elements and thus overlap adjacent non-selected elements (i.e., utilizing space previously occupied by nonselected elements). Element 110(34) is the same size as other elements 110 (however, it may be sized to be larger or smaller, if desired); elements 180(71) and 180(89) are larger than other elements 180. All other elements 110(25)-110(36), 120(25)-120(36) and 180(61)-180(120) are displayed, in this example, as being nonselected (thereby drawing attention to selected elements 110(34), 180(71) and 180(89)).

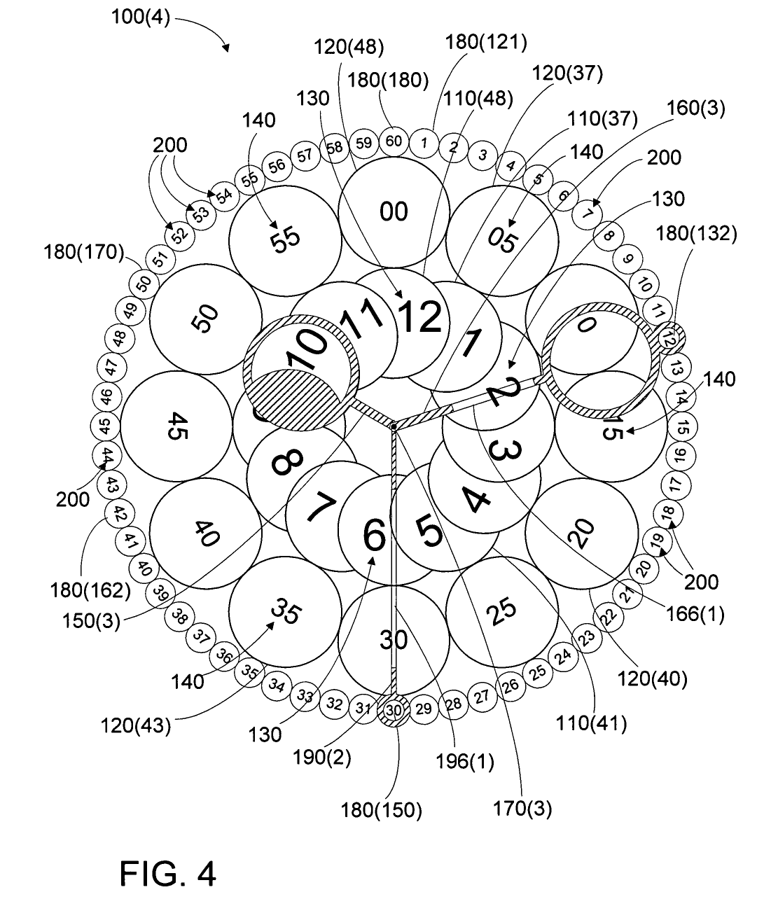

FIG. 4 shows an information display in the form of a clock display 100(4). Clock display 100(4) has circular timing elements 110(37)-110(48), circular timing elements 120(37)-120(48) and circular timing elements 180(121)-180(180), and hands 150(3), 160(3) and 190(2). A numeral 130 is associated with each of circular timing elements 110(37)-110(48); a numeral 140 is assocated with each of circular timing elements 120(37)-120(48); and a numeral 200 is associated with each of circular timing elements 180(121)-180(180). An angle of each numeral 130, 140 and 200 in clock display 100(4) corresponds to the angle of the corresponding circular timing element in its vertical position.

Minute hand 160(3) has a transparent portion 166(1) and third hand 190(2) has a transparent portion 196(1). Transparent portions 166(1) and 196(1) allow underlying features such as numerals 130, 140 to be viewed through the hands; for example, in FIG. 4, a numeral 130 (e.g., the numeral “2”) is visible through transparent portion 166(1). The ability of a viewer to see underlying numerals may reduce confusion that may otherwise result when minute hand 160(3) or third hand 190(2) overlap a numeral, especially, for example, a numeral 130 that is encircled by hour hand 150(3).

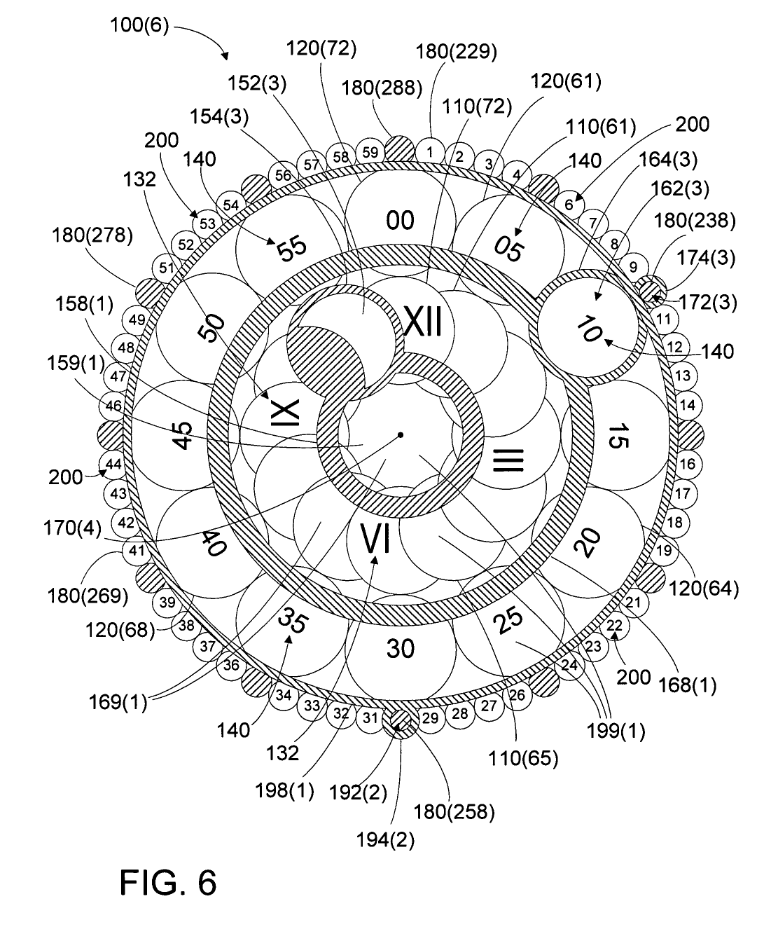

In FIG. 4, numerals 130 are substantially oriented outwardly from a center 170(3) of clock display 100(4), so that each numeral is angled along a line to center 170(3). If desired, any numeral 130 may be inverted along this line; so for example numeral “6” may be inverted so that it is apparently upside down in FIG. 4 and yet still outwardly oriented along a line to center 170(3). Other similar modifications may be made to other numerals (e.g., numerals 130, 140, 200, FIG. 5; numerals 132, 140, 200, FIG. 6; numerals 134, 140, FIG. 8; and so on).

As above, elements 110(37)-110(48), 120(37)-120(48) and 180(61)-180(180) and numerals 130, 140 and 200 may be formed by electronic display devices (e.g., LCDs) and/or light-emitting devices (e.g., an array of LEDs) and/or structure (e.g., metal, plastic, glass, ceramic). Hands 150(3), 160(3) and 190(2) may be “virtual,” formed by selective activation of electronic display devices or light emitting devices; or, as above, they may be formed by structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

FIG. 5 shows an information display in the form of a clock display 100(5). Clock display 100(5) has circular timing elements 110(49)-110(60), circular timing elements 120(49)-120(60) and circular timing elements 180(181)-180(228), and hands 150(4) and 160(4), as shown. A numeral 130 is associated with each of circular timing elements 110(49)-110(60); a numeral 140 is associated with each of circular timing elements 120(49)-120(60); and a numeral 200 is associated with each of circular timing elements 180(181)-180(228). An angle of each numeral 130 and 140 in clock display 100(5) corresponds to the angle of the corresponding circular timing element with its vertical position, while numerals 200 in clock display 100(5) are horizontal. Whereas clock displays 100(2), 100(3) and 100(4) each have sixty circular timing elements 180, clock display 100(5) has only forty-eight elements 180, with no element 180 at a position that corresponds to a circular timing element 120(49)-120(60) (since numerals in the five minute positions in timing elements 180 duplicate the numerals in corresponding timing elements 120). Like transparent portion 166(1) of minute hand 160(3) in FIG. 4, minute hand 160(4) in FIG. 5 has a transparent portion 166(2) for viewing of underlying features (e.g., the numeral “2” as shown) therethrough. Area A is discussed below and shown in FIG. 5A.

As above, elements 110(49)-110(60), 120(49)-120(60) and 180(181)-180(228) and numerals 130, 140 and 200 may be formed by electronic display devices (e.g., LCDs), light-emitting devices (e.g., an array of LEDs) and/or structure (e.g., metal, plastic, glass, ceramic). Hands 150(4) and 160(4) may be “virtual,” formed by selective activation of electronic display devices or light emitting devices; or, as above, they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

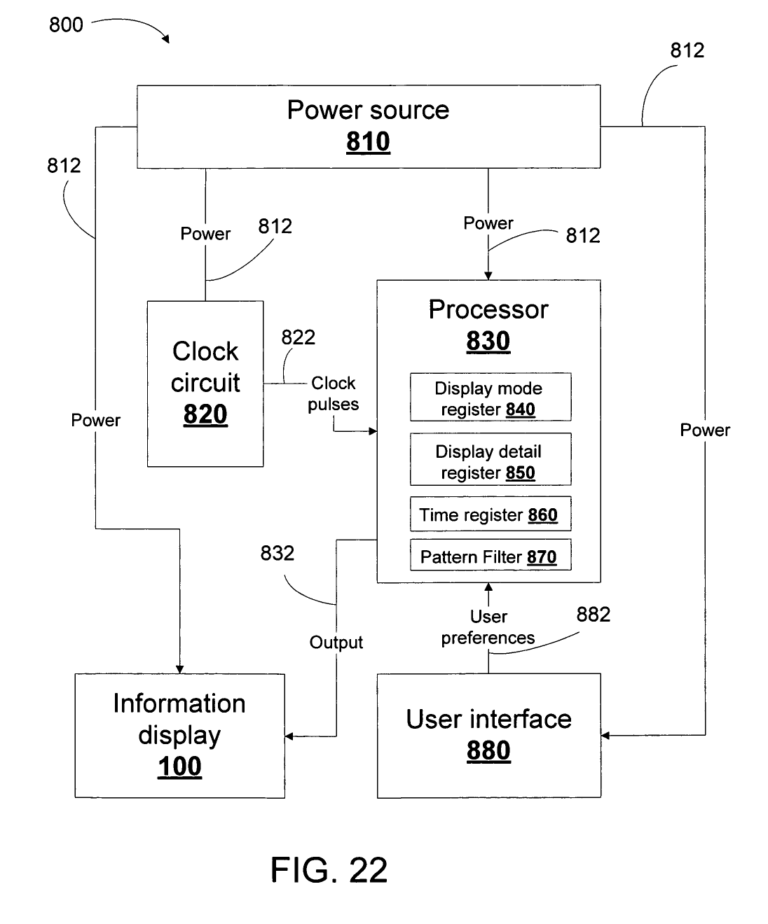

FIG. 5A is an enlarged view of area A of FIG. 5, showing all or part of elements 110(49)-110(51), 120(50), 120(51), 180(189)-180(193) and certain numerals 130, 140 and 200 formed by individually activatable display devices 205 under control of a processor (e.g., processor 830, see FIG. 22). Area B is discussed below and shown in FIG. 5B.

FIG. 5B is an enlarged view of area B of FIG. 5A, showing exemplary individually activatable display devices 205 forming portions of elements 110(49) and one numeral 130 (e.g., part of a numeral “2”). Display devices 205 may be individually activatable by a processor (e.g., processor 830, see FIG. 22).

FIG. 6 shows an information display in the form of clock display 100(6). Clock display 100(6) has circular timing elements 110(61)- 110(72), circular timing elements 120(61)-120(72), circular timing elements 180(229)-180(288), and timing rings 158(1), 168(1) and 198(1), as shown. Circular timing elements 110(61), 110(64), 110(67) and 110(70) have a Roman numeral 132, as shown; and each of circular timing elements 120(61)-120(72) includes a numeral 140. Each circular timing element 180(229)-180(288) that corresponds to positions that are not multiples of five minutes has a numeral 200, while elements 180(229)-180(288) that correspond to positions that are multiples of five minutes do not have numerals, and instead form a contrasting visual appearance, indicated by hatched areas in FIG. 6 (since numerals at five minute positions in timing elements 180 duplicate numerals in the corresponding timing elements 120).

In the foregoing descriptions, numerals 130, 140, 200, 132 may for example be formed of structure (e.g., formed of metal, glass, ceramic, and/or plastic) or they may be printed, embossed, embedded with structure, or they may be formed by selective activation of display devices of an array of display devices under control of a processor, such as described in connection with FIG. 5A and FIG. 5B.

Timing ring 158(1) is an opaque portion of a disk 159(1) that rotates about center 170(4) to indicate hours. Timing ring 158(1) includes an encircling element 154(3) that forms an aperture 152(3). Aperture 152(3) positions over one of elements 110(61)-110(72) to indicate an hour; for example, FIG. 6 shows timing ring 158(1) with aperture 152(3) over element 110(70), indicating a time that includes ten o'clock. Timing ring 168(1) is an opaque portion of a disk 169(1) that rotates about center 170(4) to indicate minutes. Timing ring 168(1) includes an encircling element 164(3) that forms an aperture 162(3), and an encircling element 174(3) that forms an aperture 172(3), as shown. Apertures 162(3) and 172(3) may position over elements 120(61)-120(72) and 180(229)-180(288) respectively to indicate a minute; for example, FIG. 6 shows timing ring 168(1) with aperture 162(3) over element 120(62) and aperture 172(3) over element 180(238), indicating a time that includes ten minutes past an hour. If the current minute past an hour is a multiple of five minutes, aperture 162(3) centers over one of elements 120(61)-120(72), while at other times aperture 162(3) centers between two adjacent elements 120(61)-120(72). Timing ring 198(1) is an opaque portion of a disk 199(1) that rotates about center 170(4) to indicate seconds, and has an encircling element 194(2) that forms an aperture 192(2). Aperture 192(2) may position over one of elements 180(229)-180(288) to indicate seconds; for example, FIG. 6 shows timing ring 198(1) with aperture 192(2) over element 180(258), indicating a time that includes thirty seconds past a minute. Each of disks 159(1), 169(1) and 199(1) has a transparent portion that connects with center 170(4) to rotate the disk; apertures 152(3), 162(3), 172(3) and 192(2) may be formed with transparent material, for example, within the appropriate disk, or they may be apertures.

As above, elements 110(61)-110(72), 120(61)-120(72) and 180(229)-180(288) and numerals 132, 140 and 200 may be formed by electronic display devices (e.g., LCDs), light-emitting devices (e.g., an array of LEDs) and/or structure (e.g., metal, plastic, glass, ceramic). Disks 159(1), 169(1) and 199(1), and timing rings 158(1), 168(1) and 198(1) may be formed by electronic display devices or light emitting devices; or they may be structural elements (e.g., formed of metal, plastic, glass, and/or ceramic) driven by a timekeeping mechanism. In one embodiment, each of the elements, rings and numerals is formed, at least in part, by an array of display devices under control of a processor, such as described in connection with FIG. 5A and FIG. 5B.

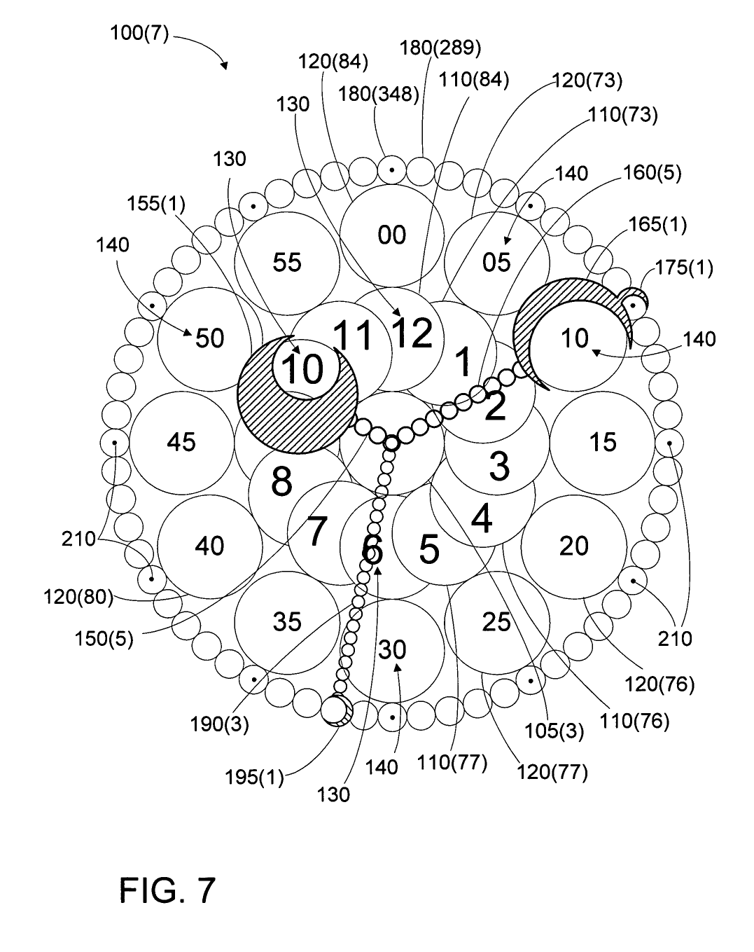

FIG. 7 shows an information display in the form of a clock display 100(7). Clock display 100(7) has a central circular timing element 105(3), circular timing elements 110(73)-1 10(84), circular timing elements 120(73)-120(84) and circular timing elements 180(289)-180(348), and hands 150(5), 160(5) and 190(3), as shown. Each of circular timing elements 110(73)-110(84) has a numeral 130; and each of circular timing elements 120(73)-120(84) has a numeral 140. Circular timing elements 180(289)-180(348) that correspond to multiples of five minutes contain a locating element 210.

Hands 150(5), 160(5) and 190(3) are formed of transparent circles through which underlying elements are visible (e.g., a numeral “6” beneath hand 190(3), and edges of elements 105(3) and 110(73) beneath hand 160(5)). Hand 150(5) includes an encircling element 155(1); hand 160(5) includes encircling elements 165(1) and 175(1); hand 190(3) includes an encircling element 195(1). Elements 155(1), 165(1), 175(1) and 195(1) are referred to herein as “encircling” elements because they identify particular elements of circular timing elements 110(73)-110(84), 120(73)-120(84), 180(289)-180(348), but do not completely encircle the circular timing element indicated.

As above, elements 105(3), 110(73)-1 10(84), 120(73)-120(84) and 180(289)-180(348) and numerals 130, 140 may be formed by electronic display devices (e.g., LCDs), light-emitting devices (e.g., an array of LEDs) and/or structure (e.g., metal, plastic, glass, ceramic). Hands 150(5), 160(5) and 190(3) may be “virtual,” formed by selective activation of electronic display devices or light emitting devices; or, as above, they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

FIG. 8 shows an information display in the form of a clock display 100(8). Clock display 100(8) has a central circular timing element 105(5), a timing element 112, circular timing elements 120(97)-120(108), circular timing elements 180(409)-180(468) and hands 150(13) and 160(13), as shown. Timing element 112 has an appearance that resembles a circle of circular timing elements 110 (e.g., circular timing elements 110(73)-110(84) in FIG. 7), but with each of the timing elements 110 having a border which is partially visible and partially invisible. Timing element 112 has numerals 134(1)-134(12), and each of circular timing elements 120(97)-120(108) has a numeral 140, as shown.

Hand 150(13) includes an encircling element 154(9) forming an aperture 152(9); hand 160(13) includes an encircling element 164(9) forming an aperture 162(9). Hand 160(13) also includes a blocking element 177. Encircling element 154(9) indicates time by encircling one of numerals 134(1)-134(12) at a time; for example, in FIG. 7 encircling element 154(9) encircling numeral 134(10) (in this case, a Roman numeral X), indicating a time including 10 o'clock. Once every five minutes, encircling element 164(9) encircles a numeral 140; at other times, a viewer may determine minutes by observing which circular timing element 180(409)-180(468) is blocked by blocking element 177.

As above, elements 105(5), 112, 120(97)-120(108) and 180(409)-180(468) and numerals 134(1)-134(12) and 140 may be formed by electronic display devices (e.g., LCDs), light-emitting devices (e.g., an array of LEDs) and/or structure (e.g., metal, plastic, glass, ceramic). Hands 150(13) and 160(13) may be “virtual,” formed by selective activation of electronic display devices or light emitting devices; or, as above, they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

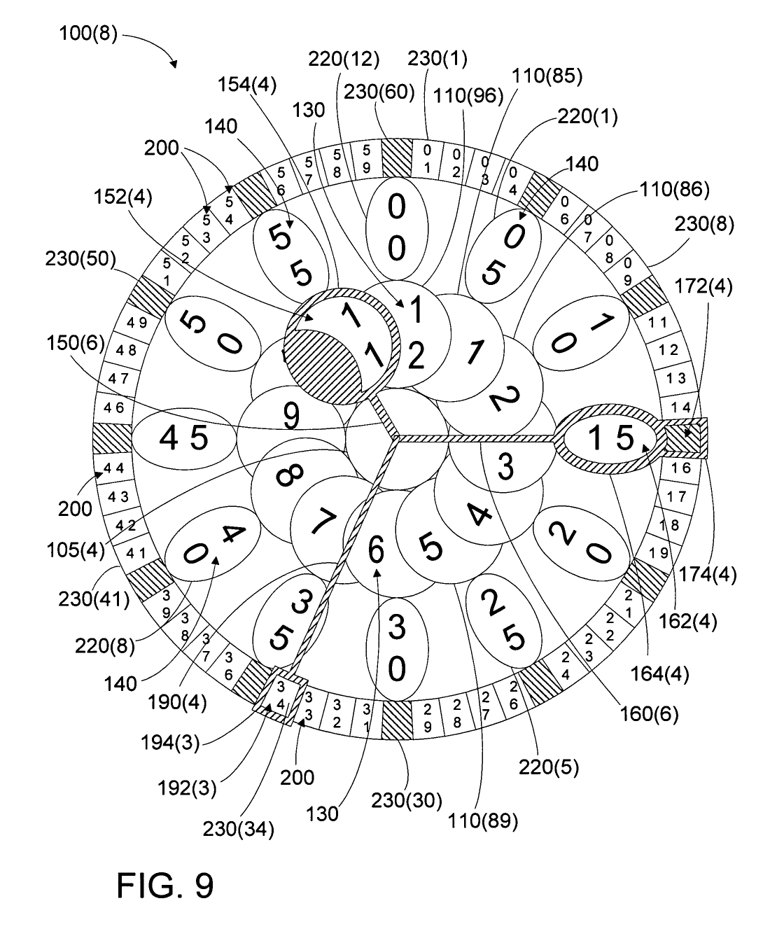

FIG. 9 shows an information display in the form of clock display 100(9). Clock display 100(9) has a central circular timing element 105(4), circular timing elements 110(85)-110(96), elliptical timing elements 220(1)-220(12) and wedge timing elements 230(1)-230(60), and hands 150(6), 160(6) and 190(4), as shown. Each of circular timing elements 110(85)-110(96) has a numeral 130; each of elliptical timing elements 220(1)-220(12) has a numeral 140. Each wedge timing element 230(1)-230(60) that corresponds to a position that is not a multiple of five minutes has a numeral 200, while elements 230(1)-230(60) that correspond to positions that are multiples of five minutes do not have numerals, and form a contrasting visual appearance, indicated by hatched areas in FIG. 9. Numerals 130, 140 and 200 appear in different orientations depending on their location within display 100(9), as shown.

Hour hand 150(6) of display 100(9) has an encircling element 154(4) that forms an aperture 152(4). Aperture 152(4) may position over one of elements 110(85)-110(96) to indicate an hour; for example, FIG. 9 shows hour hand 150(6) with aperture 152(4) over element 110(95), indicating a time that includes eleven o'clock. Minute hand 160(6) of display 100(9) has encircling elements 164(4) and 174(4) that form apertures 162(4) and 172(4), respectively. Aperture 172(4) positions over one of elements 230(1)-230(60) to indicate minutes of an hour; aperture 162(4) positions directly over one of elements 220(1)-220(12) when an indicated time includes a multiple of five minutes, otherwise aperture 162(4) positions between two of elements 220(1)-220(12). For example, FIG. 9 shows minute hand 160(6) with aperture 162(4) over element 220(3), indicating a time that includes fifteen minutes past an hour. Third hand 190(4) of display 100(9) has an encircling element 194(3) that forms an aperture 192(3). Aperture 192(3) positions over one of elements 230(1)-230 (60) to indicate seconds. For example, FIG. 9 shows third hand 190(4) with aperture 192(3) over element 230(34), indicating a time that includes thirty-four seconds past a minute. Elements 164(4), 174(4) and 194(3) are called “encircling elements” herein, even though they are not circular.

As above, elements 105(4), 110(85)-110(96), 220(1)-220(12) and 230(1)-230(60) and numerals 130, 140 and 200 may be formed by electronic display devices (e.g., LCDs), light-emitting devices (e.g., an array of LEDs) and structure (e.g., metal, plastic, glass, ceramic). Hands 150(6), 160(6) and 190(4) may be “virtual,” formed by selective activation of electronic display devices or light emitting devices; or they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

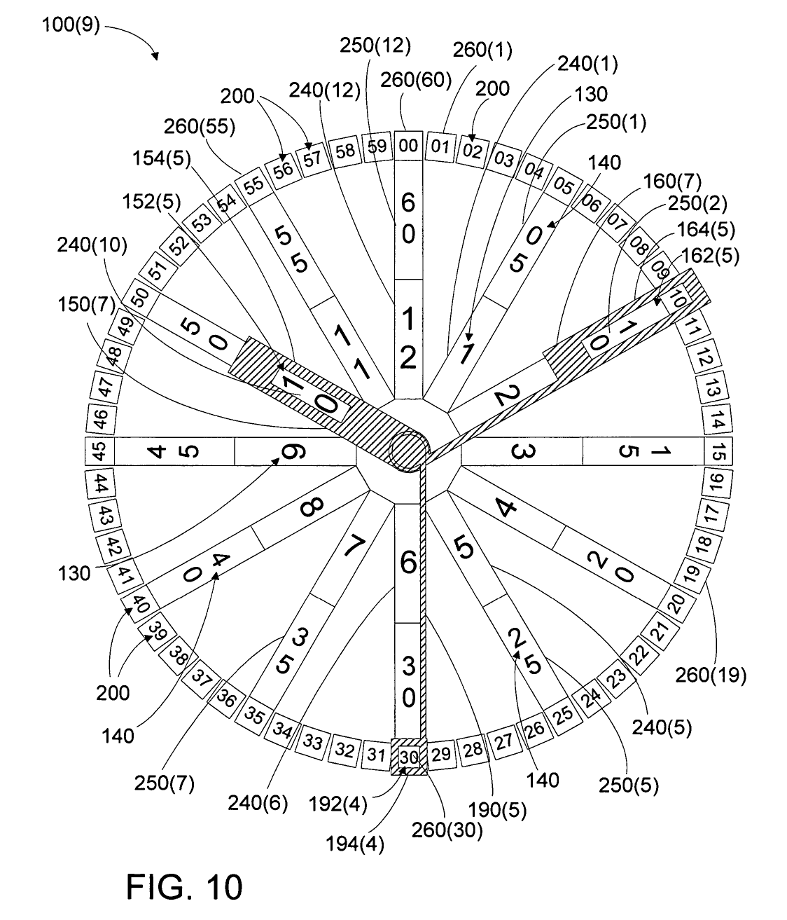

FIG. 10 shows an information display in the form of clock display 100(10). Clock display 100(10) has rectangular timing elements 240(1)-240(12), rectangular timing elements 250(1)-250(12), square timing elements 260(1)-260(60), and hands 150(7), 160(7) and 190(5), as shown. Each of rectangular timing elements 240(1)-240(12) has a numeral 130; each of rectangular timing elements 250(1)-250(12) has a numeral 140, and each of square timing elements 260(l)-260(60) has a numeral 200.

Hour hand 150(7) of display 100(10) has an encircling element 154(5) that forms an aperture 152(5). Aperture 152(5) positions over one of elements 240(1)-240(12) to indicate an hour; for example, FIG. 10 shows hour hand 150(7) with aperture 152(5) over element 240(10), indicating a time that includes ten o'clock. Minute hand 160(7) of display 100(10) has an encircling element 164(5) that forms an aperture 162(5). Aperture 162(5) positions over one of elements 260(1)-260(60) to indicate minutes of an hour; aperture 162(5) also positions directly over one of elements 250(1)-250(12) when an indicated time includes a multiple of five minutes, otherwise aperture 162(5) positions between two of elements 250(1)-250(12). For example, FIG. 10 shows minute hand 160(7) with aperture 162(5) over elements 250(2) and 260(10), indicating a time that includes ten minutes past an hour. Third hand 190(5) of display 100(10) has an encircling element 194(4) that forms an aperture 192(4). Aperture 192(4) positions over one of elements 260(1)-260 (60) to indicate seconds; for example FIG. 10 shows third hand 190(5) with aperture 192(4) over element 260(30), indicating a time that includes thirty seconds past a minute. Elements 154(5), 164(5) and 194(4) are called “encircling elements” herein, even though they are not circular.

As above, elements 240(1)-240(12), 250(1)-250(12) and 260(1)-260(60) and numerals 130, 140 and 200 may be formed by electronic display devices (e.g., LCDs), light-emitting devices (e.g., an array of LEDs) and/or structure (e.g., metal, plastic, glass, ceramic). Hands 150(7), 160(7) and 190(5) may be “virtual,” formed by selective activation of electronic display devices or light emitting devices; or they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

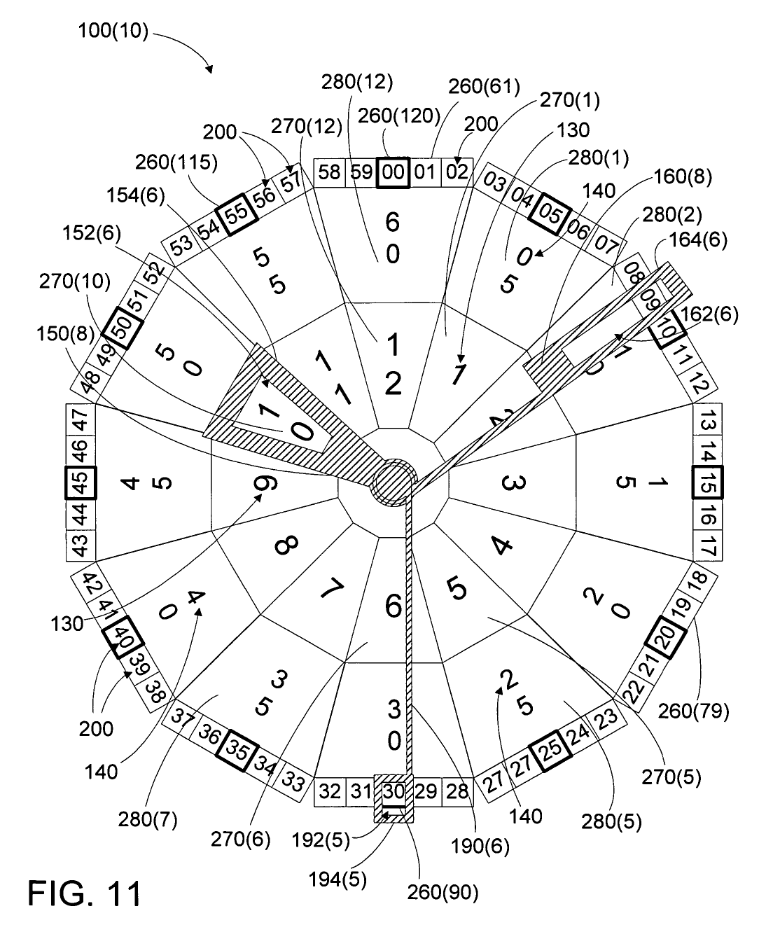

FIG. 11 shows an information display in the form of a clock display 100(11). Clock display 100(11) has trapezoidal timing elements 270(1)-270(12), trapezoidal timing elements 280(1)-280(12), square timing elements 260(61)-260(120), and hands 150(8), 160(8) and 190(6), as shown. Each of trapezoidal timing elements 280(1)-280(12) is adjacent to one of trapezoidal timing elements 270(1)-270(12), and each of square timing elements 260(61)-260(120) is adjacent to one of trapezoidal timing elements 280(1)-280(12), so that square timing elements 260(61)-260(120) form a dodecagon, as shown. Each of trapezoidal timing elements 270(1)-270(12) has a numeral 130; each of trapezoid timing elements 280(1)-280(12) has a numeral 140, and each of square timing elements 260(61)-260(120) has a numeral 200.

Hour hand 150(8) of display 100(11) has an encircling element 154(6) that forms an aperture 152(6). Aperture 152(6) positions over one of elements 270(1)-270(12) to indicate an hour; for example, FIG. 11 shows hour hand 150(8) with aperture 152(6) over element 270(10), indicating a time that includes ten o'clock. Minute hand 160(8) of display 100(11) has an encircling element 164(6) that forms an aperture 162(6). Aperture 162(6) positions over one of elements 260(61)-260(120) to indicate minutes of an hour; aperture 162(6) also positions directly over one of elements 250(1)-250(12), but positions directly over a numeral 140 when an indicated time is a multiple of five minutes, otherwise aperture 162(6) positions over a portion of one of elements 250(1)-250(12) that does not contain a numeral 140. For example, FIG. 11 shows minute hand 160(8) with aperture 162(6) over elements 280(2) and 260(69), with no numeral 140 visible within aperture 162(6). Minute hand 160(8) indicates a time that includes nine minutes past an hour. Third hand 190(6) of display 100(11) has an encircling element 194(5) that forms an aperture 192(5). Aperture 192(5) positions over one of elements 260(61)-260 (120) to indicate seconds; for example in FIG. 10 shows third hand 190(6) with aperture 192(4) over element 260(90), indicating a time that includes thirty seconds past a minute. Elements 154(6), 164(6) and 194(5) are called “encircling elements” herein, although they are not circular.

As above, elements 260(1)-260(60), 270(1)-270(12) and 280(1)-280(12) and numerals 130, 140 and 200 may be formed by electronic display devices (e.g., LCDs), light-emitting devices (e.g., an array of LEDs) and/or structure (e.g., metal, plastic, glass, ceramic). Hands 150(8), 160(8) and 190(6) may be “virtual,” formed by selective activation of electronic display devices or light emitting devices; or they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

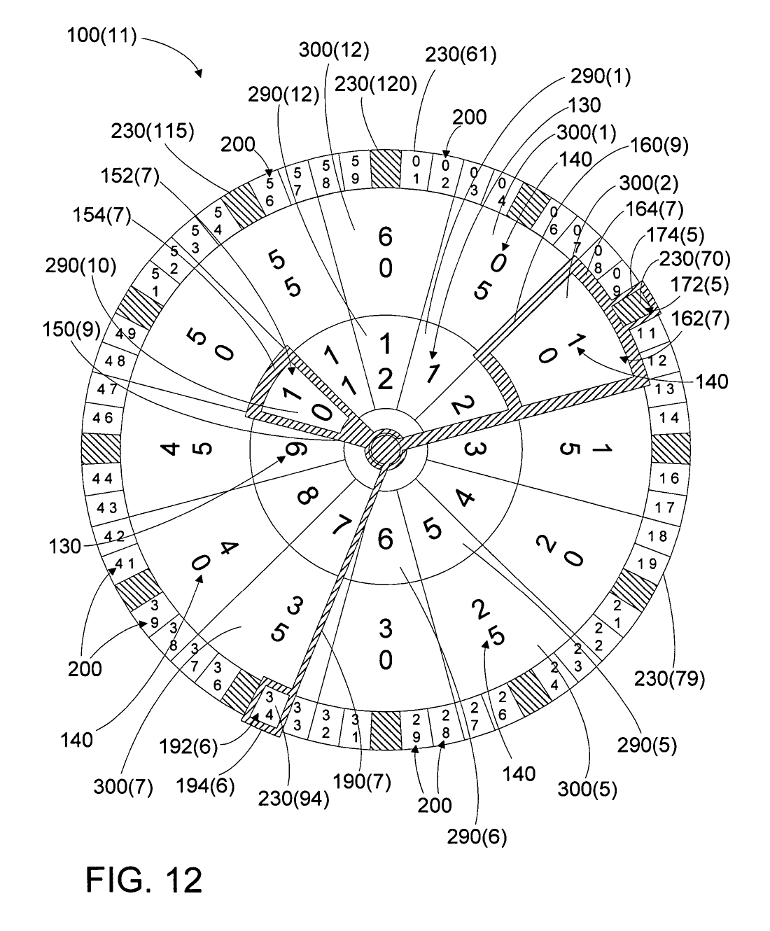

FIG. 12 shows an information display in the form of a clock display 100(12). Clock display 100(12) has wedge timing elements 290(1)-290(12), wedge timing elements 300(1)-300(12), wedge timing elements 230(61)-230(120), and hands 150(9), 160(9) and 190(7), as shown. Each of wedge timing elements 300(1)-300(12) is adjacent to one of wedge timing elements 290(1)-290(12), and each of wedge timing elements 230(61)-230(120) is adjacent to one of wedge timing elements 300(1)-300(12), so that wedge timing elements 230(61)-230(120) form a circle, as shown. Each of wedge timing elements 290(1)-290(12) has a numeral 130; and each of wedge timing elements 300(1)-300(12) has a numeral 140. Each wedge timing element 230(61)-230(120) that corresponds to a position that is not a multiple of five minutes displays a numeral 200, while elements 230(61)-230(120) that correspond to positions that are multiples of five minutes do not display numerals, and form a contrasting visual appearance, indicated by hatched areas in FIG. 12. Numerals 130, 140 and 200 appear in different orientations depending on their location within display 100(12), as shown.

Hour hand 150(9) of display 100(12) has an encircling element 154(7) that forms an aperture 152(7). Aperture 152(7) positions over one of elements 290(1)-290(12) to indicate an hour; for example, FIG. 12 shows hour hand 150(9) with aperture 152(7) over element 290(10), indicating a time that includes ten o'clock. Minute hand 160(9) of display 100(12) has an encircling element 164(7) that forms an aperture 162(7). Aperture 172(5) positions over one of elements 230(61)-230(120) to indicate minutes of an hour; aperture 162(7) positions over one of elements 300(1) - 300(12), but centers over a numeral 140 only when an indicated time is a multiple of five minutes. For example, FIG. 12 shows minute hand 160(9) with aperture 172(5) positioned over element 230(70), and with aperture 162(7) positioned over element 300(2) and centered over a numeral 140 (e.g., the numeral “10”) to indicate a time that includes ten minutes past an hour. Third hand 190(7) of display 100(12) has an encircling element 194(6) that forms an aperture 192(6). Aperture 192(6) positions over one of elements 230(61)-230 (120) to indicate seconds; for example FIG. 12 shows third hand 190(7) with aperture 192(6) over element 230(94), indicating a time that includes thirty-four seconds past a minute. Elements 154(7), 164(7) and 194(6) are called “encircling elements” herein, althrough that they are not circular.

As above, elements 230(61)-230(120), 290(1)-290(12) and 300(1)-300(12) and numerals 130, 140 and 200 may be formed by electronic display devices (e.g., LCDs), light-emitting devices (e.g., an array of LEDs) and/or structure (e.g., metal, plastic, glass, ceramic). Hands 150(9), 160(9) and 190(7) may be “virtual,” formed by selective activation of electronic display devices or light emitting devices; or they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

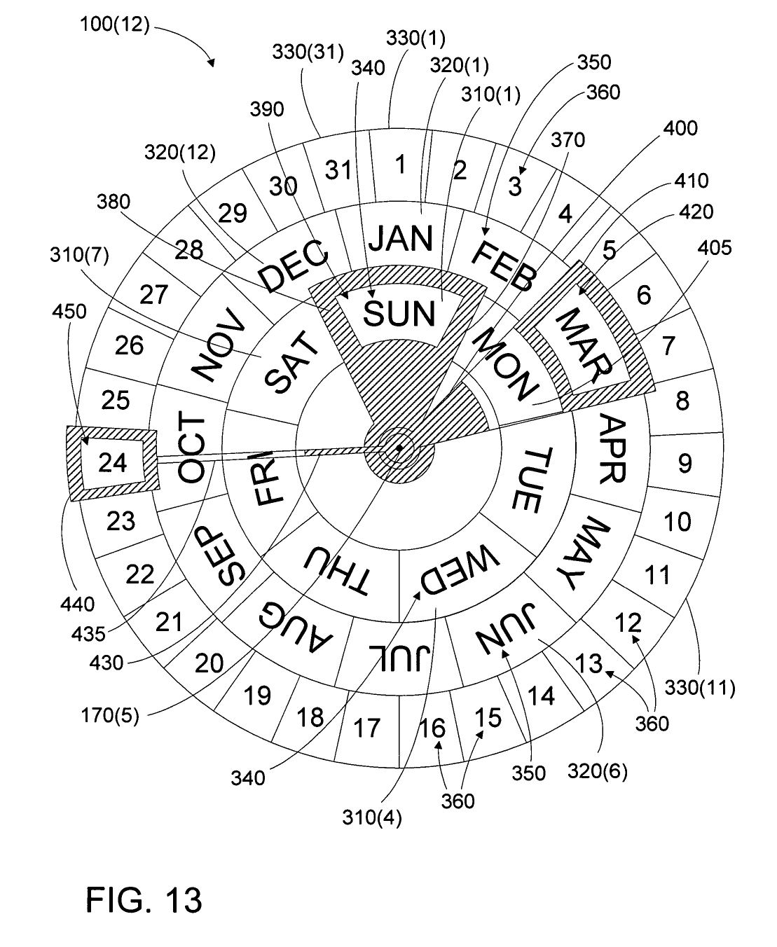

FIG. 13 shows an information display in the form of a calendar display 100(13). Calendar display 100(13) has wedge timing elements 310(1)-310(7), wedge timing elements 320(1)-320(12), wedge timing elements 330(1)-330(3 1), and hands 370, 400 and 440, as shown. Each set of wedge timing elements 310(1)-310(7), 320(1)-320(12) and 330(1)-330(31) forms a circle, as shown. Each of wedge timing elements 310(1)-310(7) has a numeral day of week indicia 340; each of wedge timing elements 320(1)-320(12) has month indicia 350, and each of wedge timing elements 330(1)-330(31) has a numeral 360, as shown.

Day of week hand 370 of display 100(13) has an encircling element 380 that forms an aperture 390. Aperture 390 positions over one of elements 310(1)-310(7) to indicate a day of a week; for example, FIG. 13 shows day of week hand 370 with aperture 390 over element 310(1), indicating Sunday. Month hand 400 of display 100(13) has an encircling element 410 that forms an aperture 420. Aperture 420 positions over one of elements 320(1)-320(12) to indicate a month; for example, FIG. 13 shows month hand 400 with aperture 420 positioned over element 320(3), indicating March. Month hand 400 also includes a transparent element 405 so that when hand 400 is over hand 370, day of week indicia 340 may be viewed through element 405. Day of month hand 430 of display 100(13) has an encircling element 440 that forms an aperture 450. Aperture 450 positions over one of elements 330(1)-330(31) to indicate day of a month; for example FIG. 13 shows day of month hand 430 with aperture 450 over element 330(24), indicating a twenty-fourth day of a month. Day of month hand 440 also includes a transparent element 435 so that when hand 400 is over hand 370 and/or hand 400, underlying indicia may be viewed through element 435. A day and date indicated by the positions of hands 370, 400 and 440 in FIG. 13 is Sunday, March 24.

In calendar display 100(13), elements 380, 410 and 440 are called “encircling elements,” even though they are not circular. Other embodiments of calendar display may include timing elements that are not wedge shaped but are circles, ovals, hexagons, squares, rectangles and so forth; the timing elements may be arranged adjacent to each other as in calendar display 100(13), or the timing elements may overlap or may be arranged so that they do not touch one another. Hands of calendar displays may include encircling elements of shape that corresponds to the shape of the timing elements. Calendar displays may be configured to display subsets of the information shown in display 100(13) (displaying, for example, only month and day of month timing elements).

In FIG. 13, indicia 340, 350, 360 are arranged outwardly from a center 170(5) of display 100(12). However, these indicia may be oriented differently without departing from the scope hereof.

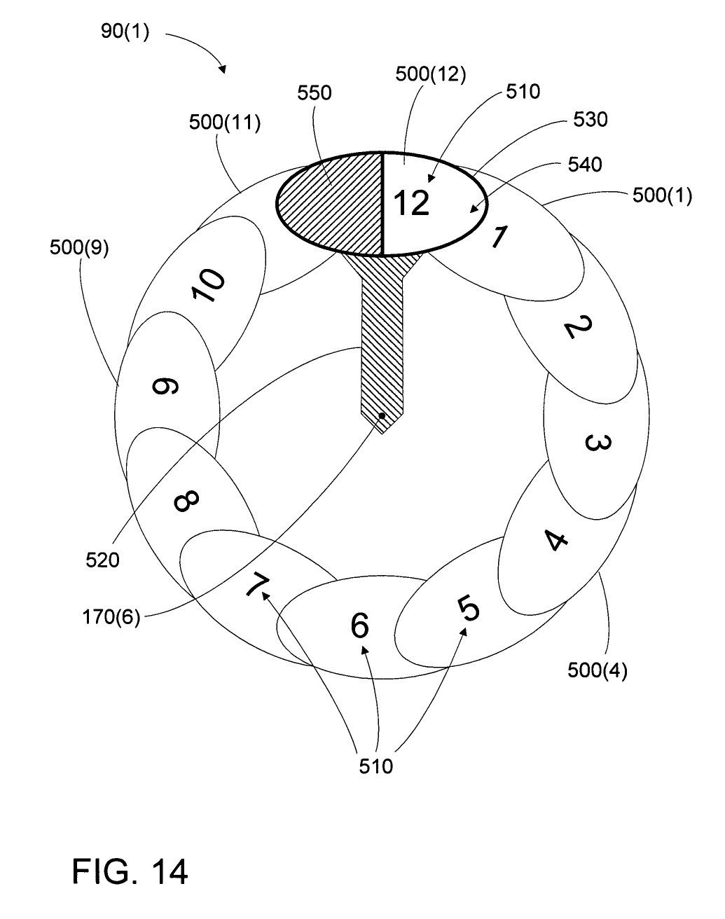

FIG. 14 shows a portion 90(1) of a clock display in which ovals 500(1)-500(12) overlap in a manner similar to circular timing elements 110(1)-110(96). Each oval 500(1)-500(12) has a numeral 510. A hand 520 with an encircling element 530 forms an aperture 540; in FIG. 14, hand 520 positions over oval 500(12) such that aperture 540 encircles one numeral 510 (e.g., the numeral “12”) to indicate time. A blocking portion 550 blocks an overlapping portion of oval 500(11) for clarity.

In FIG. 14, indicia 510 are arranged outwardly from a center 170(6) of display 90(1). However, these indicia may be oriented differently without departing from the scope hereof.

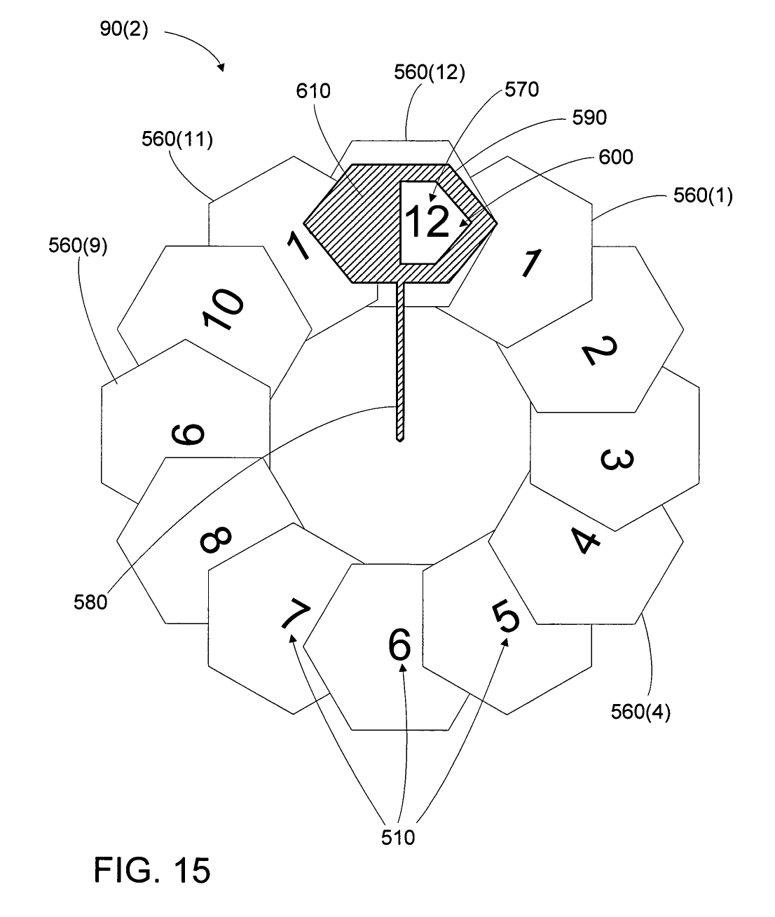

FIG. 15 shows a portion 90(2) of a clock display in which hexagons 560(1)-560(12) overlap in a manner similar to circular timing elements 110(1)-110(96) and ovals 500(1)-500(12). Each hexagon 560(1)-560(12) includes a numeral 570. A hand 580 with an encircling element 590 forms an aperture 600; in FIG. 15, hand 580 positions over hexagon 560(12) such that aperture 600 encircles one numeral 570 (e.g., the numeral “12”) to indicate time. A blocking portion 610 partially blocks an overlapping portion of hexagon 560(11) for clarity. The configuration of hands 520 and 580 (i.e., clearly encircling the numeral “12” while partially or completely blocking the numeral “11”) makes it easy for a viewer to determine an indicated time with a quick glance.

As in other figures, indicia 510 may be oriented in different ways without departing from the scope hereof.

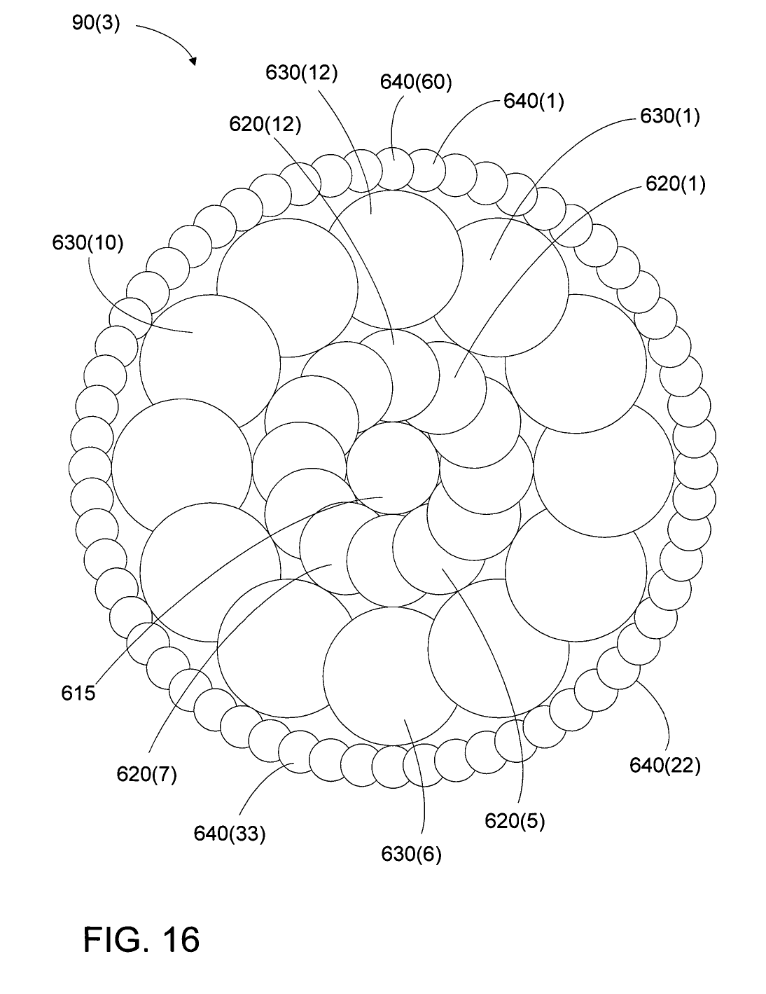

Information displays may utilize overlapping shapes to display any type of information, in contrast to the use of overlapping shapes to display only hours in clock displays 100(1)-100(9). FIG. 16 shows a portion 90(3) of an information display with a central circular element 615, and with circular elements 620(1)-620(12), 630(1)-630(12) and 640(1)-640(60). Each set of circular elements 620(1)-620(12), 630(1)-630(12) and 640(1)-640(60) overlaps in a manner similar to circular timing elements 110(1)-110(96). It will be appreciated that hands or dials may be used with elements 620(1)-620(12), 630(1)-630(12) and 640(1)-640(60) to form a clock display, and that such hands or dials may be similar to hands or dials used in other clock display embodiments, including for example encircling elements, blocking portions, transparent portions, and so forth.

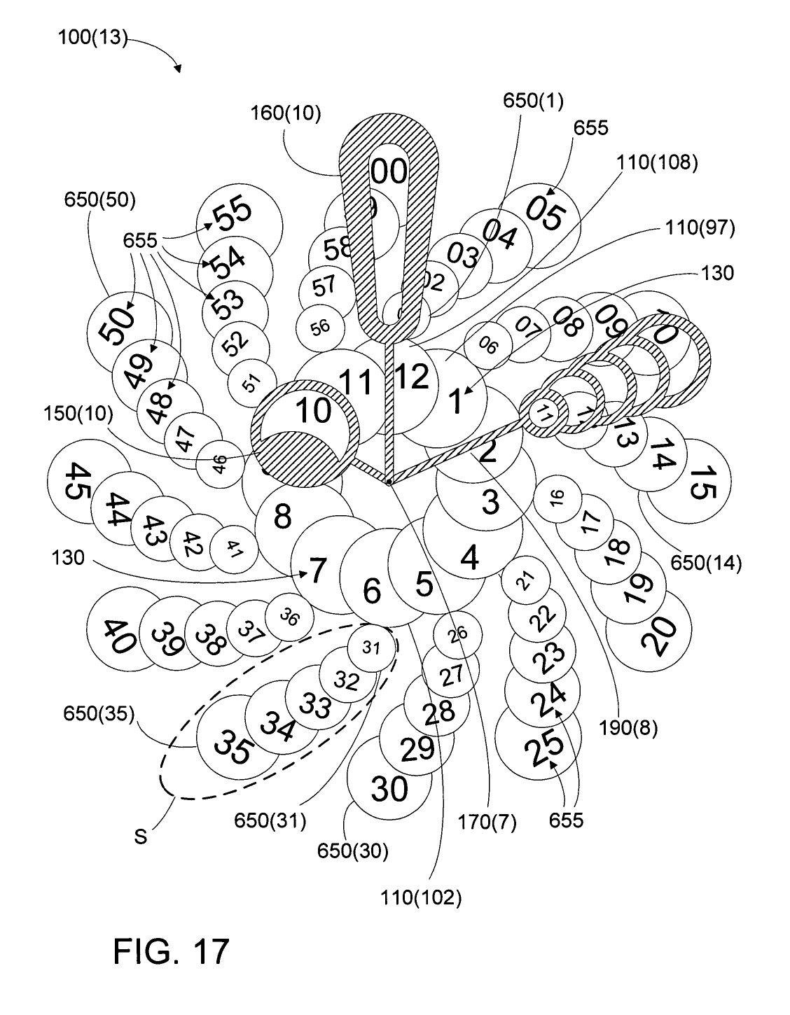

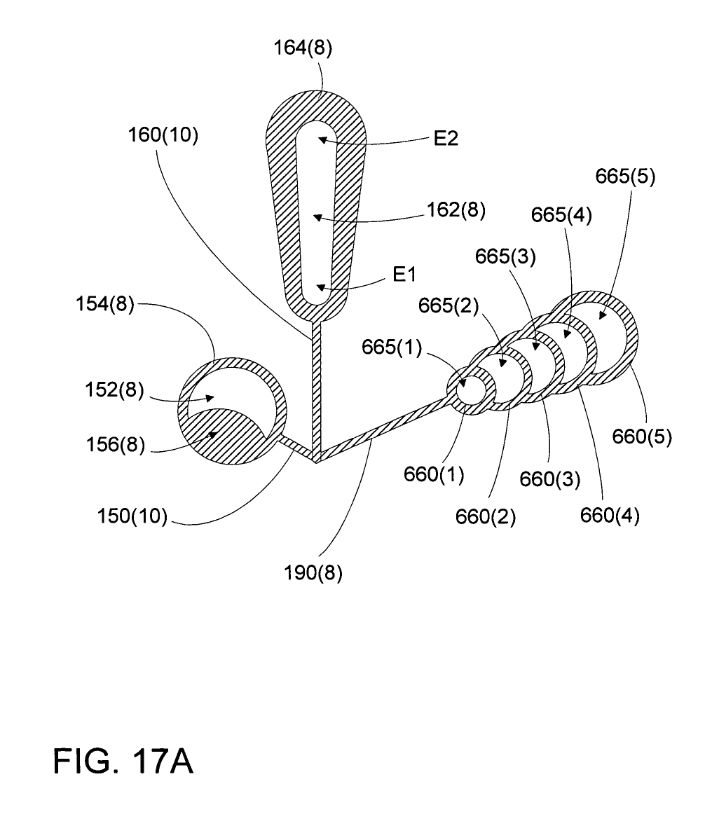

FIG. 17 shows a clock display 100(14), in accord with one embodiment. Clock display 100(14) includes circular timing elements 110(97)-110(108), each having a numeral 130, and circular timing elements 650(1)-650(60), each having a numeral 655, as shown. Clock display 100(14) also includes an hour hand 150(10), a minute hand 160(10) and a third hand 190(8); details of these hands are illustratively shown in FIG. 17A. Clock display 100(14) uses space of a clock face advantageously by arranging circular timing elements corresponding to minutes and/or seconds in spirals; circular timing elements 650(1)-650(60) are arranged in groups of five such that a first member of each group is a small circle adjacent to one of circular timing elements 110(97)-110(108), and subsequent members of each group are incrementally larger circles disposed outwards and clockwise (relative to a center 170(7)) from the first member of the group. For example, in FIG. 17, a spiral group denoted by S consists of circular timing elements 650(31)-650(35), with element 650(31) a small circle adjacent to element 110(102), and each of elements 650(32)-650(35) disposed outwards and six degrees clockwise (relative to center 170(7)) from the previous element 650(31)-650(34).

The orientation of each element 650(1)-650(60) six degrees away from each adjacent element 650(1)-650(60) enables configuration of minute hand 160(10) and third hand 190(8) such that at a given time, aperture 162(8) and/or one of apertures 665(1)-665(5) (see FIG. 17A) centers over one numeral 655 of one of elements 650(1)-650(60). This configuration allows the elements that are nearer the end of the spiral (e.g., elements 650(1)-650(60) that are multiples of five) to be larger, thus more intuitively important than the smaller elements. However, all elements 650(1)-650(60) are larger in the spiral configuration than they would be if simply arranged in a circle (e.g., like circular timing elements 180(1)-180(180)). Thus, the spiral arrangement makes effective use of space available in a clock face.

Spiral groups (e.g., like spiral group S of FIG. 17) may be formed from any number of elements (e.g., elements 650(1)-650(60)). For example, 60 minutes or seconds may be divided into equal spiral groups having 2, 3, 4, 5, 6, 10, 12, 15, 20 or 30 elements; alternatively, spiral groups that do not have an equal number of elements in each group may be used. As above, elements 110(97)-110(108) and 650(1)-650(60) and numerals 130, 655 may be formed by electronic display devices (e.g., LCDs), light-emitting devices (e.g., an array of LEDs) and/or structure (e.g., metal, plastic, glass, ceramic). Hands 150(10), 160(10) and 190(8) may be “virtual,” formed by selective activation of electronic display devices or light emitting devices; or they may be structural elements (e.g., formed of metal, plastic, glass, and/or ceramic) driven by a timekeeping mechanism. In one embodiment, each of the elements, hands and numerals is formed, at least in part, by an array of display devices under control of a processor, such as described in connection with FIG. 5A and FIG. 5B.

Use of display devices under control of a processor may also enable configurations wherein apertures 162(8) and/or 665(1)-665(5) (see FIG. 17A) change depending on a position of the corresponding hand. For example, aperture 162(8) may be appropriately sized and centered over a corresponding circular element 650 (i.e., aperture 162(8) may change, over a five minute cycle, from a small aperture near end E1 of FIG. 17A to a large aperture near end E2 of FIG. 17A, and back again to repeat the next cycle), to provide additional clarity to a viewer. Either a minute hand or a third hand may use either of the designs disclosed as hands 160(10) and 190(8), or other designs that allow a viewer to uniquely identify a displayed time.

FIG. 17A shows details of hour hand 150(10), minute hand 160(10) and third hand 190(8) of clock display 100(14). Hour hand 150(10) includes an encircling element 154(8) forming an aperture 152(8) to indicate an hour, and a blocking portion 156(8) to block an overlapping element 110 (see FIG. 17). Minute hand 160(10) includes an encircling element 164(8) forming an aperture 162(8) to indicate a minute. Aperture 162(8) is narrower at a near end E1 and larger at a far end E2, to accommodate the size of numerals 655 displayed therein. Third hand 190(8) includes encircling elements 660(1)-660(5) forming apertures 665(1)-665(5) that are successively larger to accommodate the size of numerals 655 displayed therein.

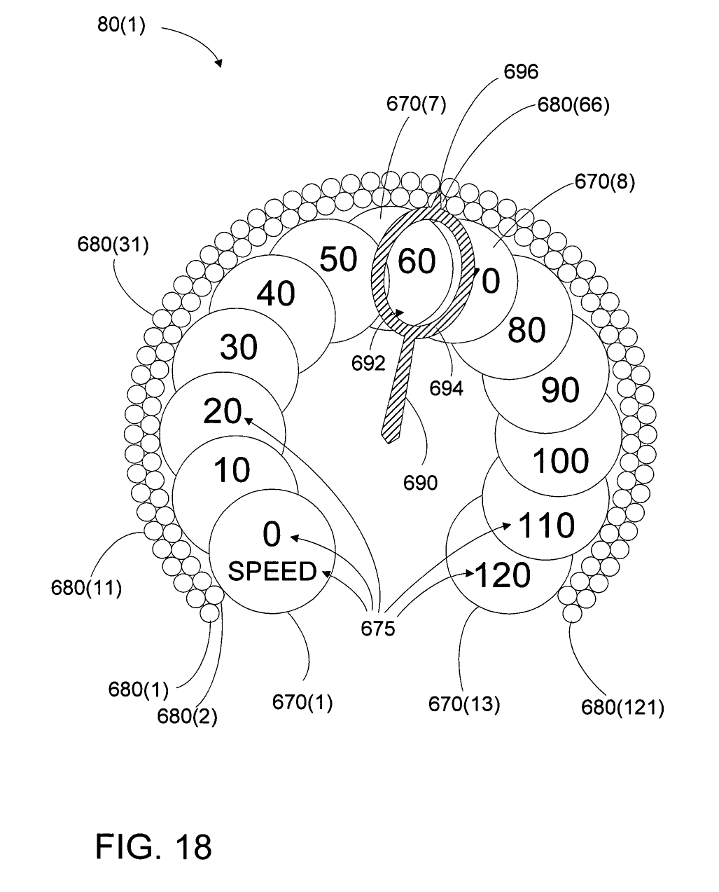

Information displays other than clock displays may utilize circular elements and encircling elements for clarity of viewing. FIG. 18 shows an information display 80(1), in accord with one embodiment. FIG. 18 displays speed information (i.e., a speed number within a predetermined range of up to 120 MPH) to an operator of a motor vehicle, and includes circular display elements 670(1)-670(13), circular display elements 680(1)-680(121), and a pivoting pointing element 690. Circluar display elements 670(1)-670(13) are arranged along an arc, and circular display elements 680(1)-680(121) are arranged on an arc adjacent to circluar display elements 670(1)-670(13), as shown. Circular display elements 670(1)-670(13) correspond to coarse speed numbers (e.g., ten mile per hour increments) and have indicia 675 to indicate a meaning corresponding to each element. Circular display elements 680(1)-680(121) correspond to fine speed numbers (e.g., one mile per hour increments). Pointing element 690 includes a tip 696 and an encircling element 694 forming an aperture 692. A viewer utilizing display 80(1) may determine a current speed number by looking within aperture 692 to obtain an coarse speed number, and/or may utilize the information available by looking at tip 696 to obtain a more precise speed number. In FIG. 18, pointing element 690 indicates a speed number of sixty-five miles per hour.

As described above with respect to other information displays, elements 670(1)- 670(13) and 680(1)-680(121) and indicia 675 may be formed by electronic display devices (e.g., LCDs), light-emitting devices (e.g., an array of LEDs) and/or structure (e.g., metal, plastic, glass, ceramic). Pointing element 690 may be a “virtual” pointing element formed by selective activation of electronic display devices or light emitting devices; or it may be a structural element (e.g., formed of metal, plastic, glass, and/or ceramic) driven by an actuator. In one embodiment, each of the elements, pointing element and indicia is formed, at least in part, by an array of display devices under control of a processor, such as described in connection with FIG. 5A and FIG. 5B.

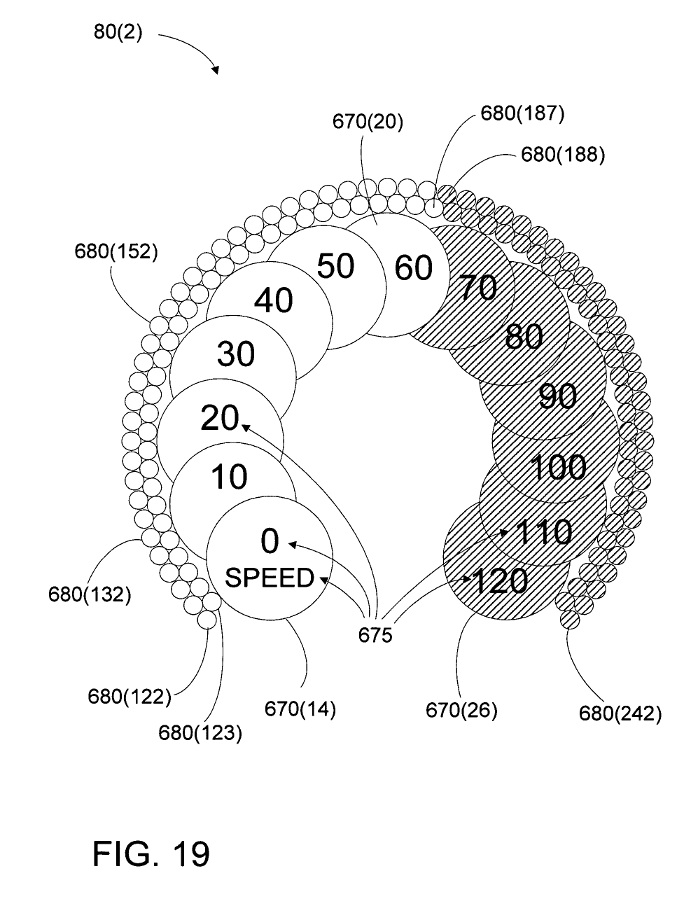

FIG. 19 shows an information display 80(2), in accord with one embodiment. Like information display 80(1), information display 80(2) displays speed information to an operator of a motor vehicle. Information display 80(2) includes circular display elements 670(14)-670(26) and circular display elements 680(122)-680(242). Circular display elements 670(14)-670(26) correspond to coarse speed numbers (e.g., ten mile per hour increments), and indicia 675 indicate a number corresponding to each element. Circular display elements 680(122)-680(242) correspond to fine speed numbers (e.g., one mile per hour increments). Each of display elements 670(14)-670(26) and 680(122)-680(242) exhibits a selected appearance when speed is greater than or equal to the number corresponding to the element, and exhibits a non-selected appearance when speed is less than the number corresponding to the element.

The selected and non-selected appearances may be generated by different states of discrete elements (e.g., lamps or display segments that correspond to each of display elements 670(14)-670(26) and 680(122)-680(242)), or by different states of display devices under control of a processor. For example, in FIG. 18, elements 670(14)-670(20) and 680(122)-680(187) have a selected appearance (shown as elements with a clear interior), while elements 670(21)-670(26) and 680(188)-680(242) have a non-selected appearance (shown as elements with hatched interior). The selected appearance may be generated by activated lamps or display segments that correspond to each of elements 670(14)-670(20) and 680(122)-680(187), or by bright display devices forming elements 670(14)-670(20) and 680(122)-680(187). The non-selected appearance may be generated by unactivated lamps or darker display segments that correspond to each of elements 670(21)-670(26) and 680(188)-680(242), or by dark display devices forming elements 670(21)-670(26) and 680(188)-680(242). Collectively, the appearance of elements 670(14)-670(26) and 680(122)-680(242) conveys to a viewer that an indicated speed is sixty-five miles per hour. This number (65 mph) is a number within a predetermined range of up to 120 mph.

As above, elements 670(14)-670(26) and 680(122)-680(242) and indicia 675 may be formed by electronic display devices (e.g., LCDs), light-emitting devices (e.g., an array of LEDs) and/or structure (e.g., metal, plastic, glass, ceramic). In one embodiment, each of the elements and indicia is formed, at least in part, by an array of display devices under control of a processor, such as described in connection with FIG. 5A and FIG. 5B.

It will be appreciated that the displays of FIG. 18 and FIG. 19 may be generalized to show a number within a predetermined range. For example, in a vehicle, such displays may be used to communicate rotational speed (e.g., a tachometer), temperature, voltage, pressure and so forth. On a computer monitor, such displays may be used to communicate elapsed time, percentage of a task completed, resources used, and so forth. On an audiovisual device, such displays may be used to communicate volume levels, recording levels, elapsed time, pitch, brightness, contrast, and so forth.

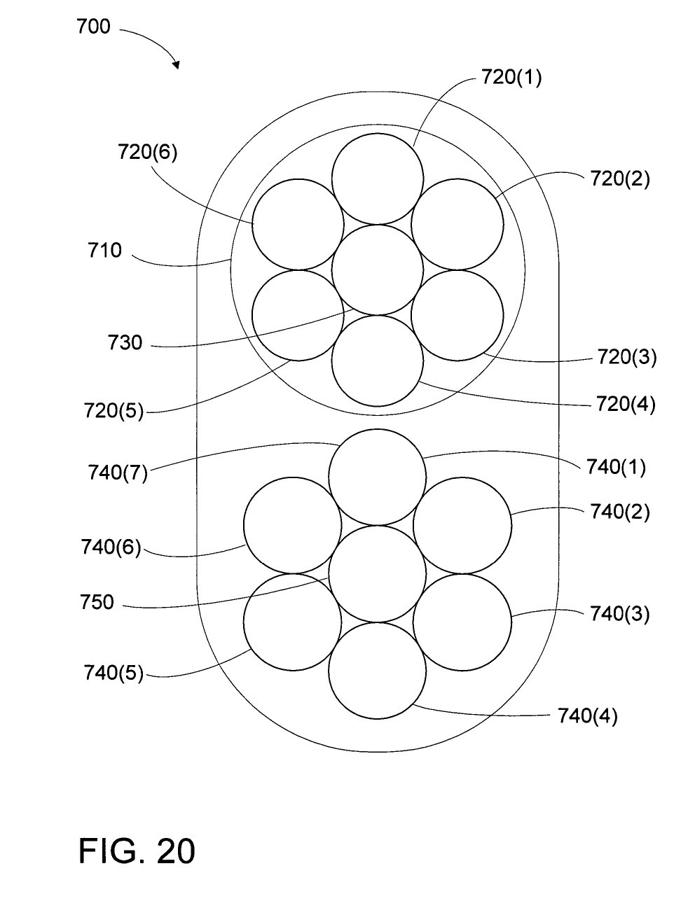

FIG. 20 shows a user interface 700 including one information display 710. User interface 700 enables a user to receive information from, and provide input to an electronic device, for example. Information display 710 includes circular displays 720(1)-720(6) and circular display 730 for displaying information. User interface 700 also includes buttons 740(1)-740(6) and 750 for providing input. Any of buttons 740(1)-740(6) and 750 may correspond to functions such as movement of a cursor (e.g., “arrow” keys), choosing among fields in a list, or selection of a chosen field (e.g., an “enter” key).

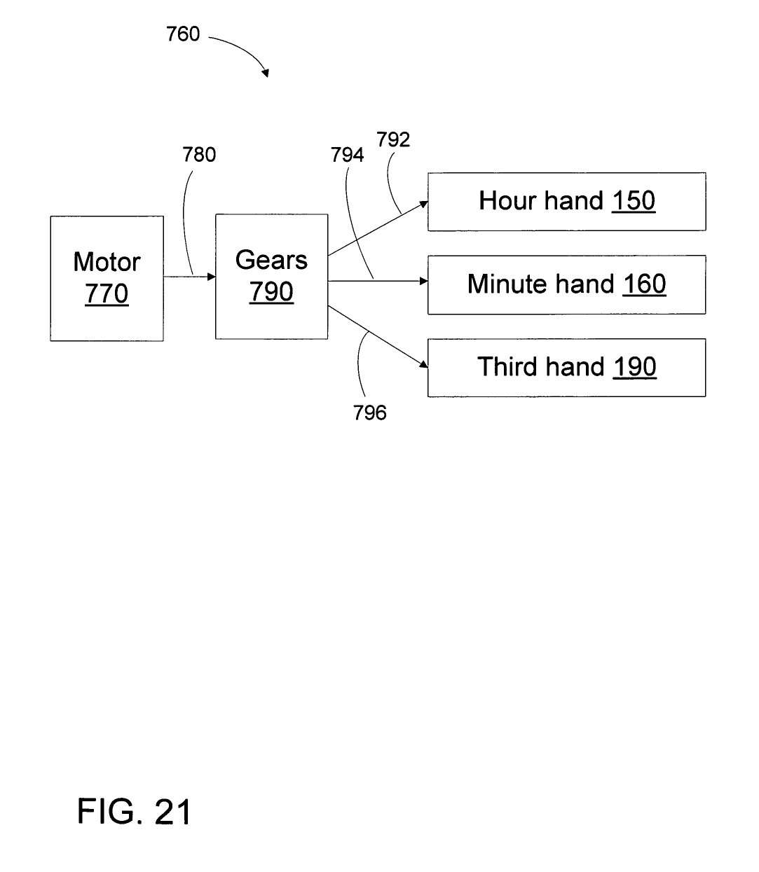

FIG. 21 is a schematic illustration of a timekeeping mechanism 760. Mechanism 760 includes a motor 770 which may, for example, be mechanically powered (e.g., driven by a spring or gravity) or an electric motor. Motor 770 provides power through a mechanical coupling 780 to gears 790. For example, motor 770 and gears 790 can drive any of clock displays 100(1), 100(2), 100(4)-100(12) or 100(14). Gears 790 are configured to move an hour hand 150, a minute hand 160 and, optionally, a third hand 190 to display time. Gears 790 may operate each of hour hand 150, minute hand 160 and, optionally, third hand 190 in continuous motion, or may operate any of these hands so that the hand jumps when an increment of time elapses, using for example the mechanism disclosed in U.S. Pat. No. 3,712,048. Gears 790 are connected to hour hand 150 through a mechanical coupling 792, to minute hand 160 through a mechanical coupling 794 and, optionally, to third hand 190 through a mechanical coupling 796.

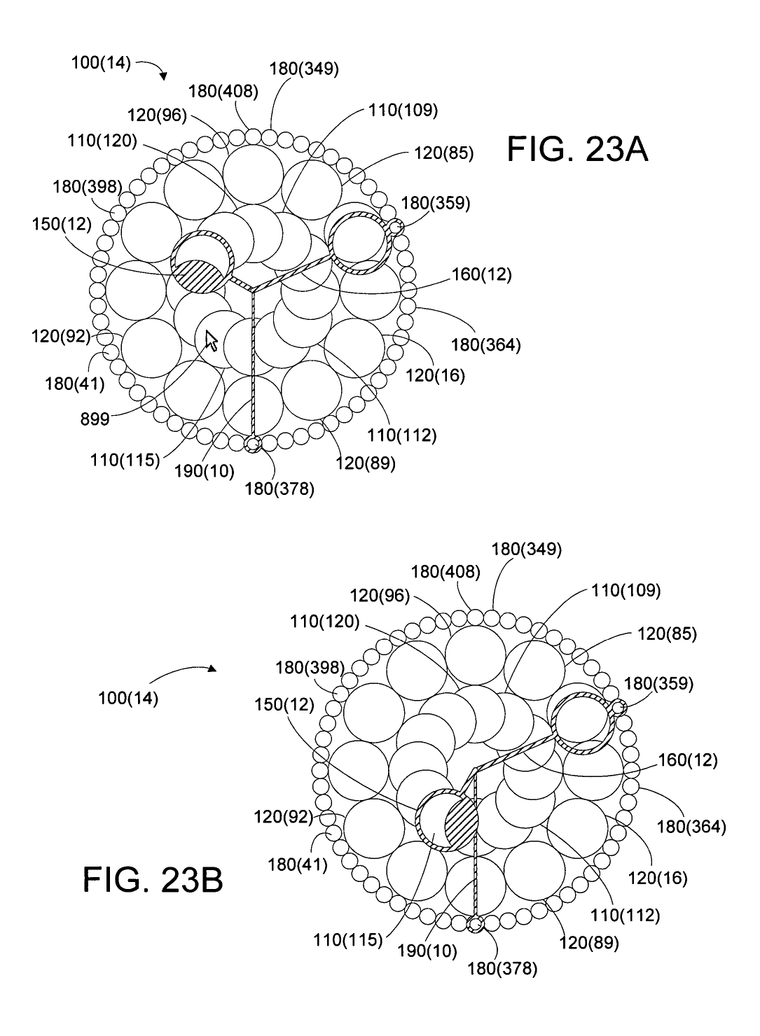

FIG. 22 is a schematic diagram of a system embodiment 800 illustrating a power source 810, a clock circuit 820, a processor 830, and a user interface 880, for use with an information display 100. User interface 880 has for example buttons or knobs associated with information display 100 (e.g., any of clock displays 100(1)-100(15)). User interface 880 communicates user preferences 882 to processor 830, which acknowledges preferences 882 by providing output 832 to clock display 100. User interface 880 may further allow the user to set up display, color and light intensity preferences, and/or set or change the time displayed (see FIG. 23A and FIG. 23B). Power source 810 (e.g., a battery) supplies power 812 to clock circuit 820, processor 830, user interface 880 and clock display 100, as shown. A clock circuit 820 (e.g., a real time clock) may generate a clock signal (e.g., clock pulses 822) that correspond to increments of time. Clock circuit 820 communicates clock pulses 822 to a processor 830. It will be appreciated that clock circuit 820 and processor 830 may be integrated into a single component; in such an embodiment, processor 830 may include a display mode register 840, a display detail register 850, a time register 860 and a pattern filter 870. Processor 830 counts pulses 822 and updates current time data in time register 860. The user may enter preferences as to the number and time units of displays as display mode data in display mode register 840; preferences as to the appearance and position of the displays as display detail data in display detail register 850 and preferences as to the current time setting to initialize current time data in time register 860. Pattern filter 870 may utilize the current time data, the display mode data and the display detail data to generate output 832 that includes signals that drive corresponding display elements of display 100. Output 832 may be a signal bus that transmits multiple signals, such as one signal to each timing element within clock display 100, or output 832 may be signals that can be decoded by clock display 100 to activate appropriate timing elements therein.

It should be apparent that processor 830 may be a microcontroller or a plurality of devices or integrated circuits (e.g., real time clock, etc.).

FIG. 23A and FIG. 23B show a clock display 100(15) during a time input process. Clock display 100(15) includes circular timing elements 110(109)-110(120), circular timing elements 120(85)-120(96), circular timing elements 180(349)-180(408), an hour hand 150(12), a minute hand 160(12) and a third hand 190(10). The circular timing elements and hands of clock display 110(14) are formed by electronic display devices (e.g., LCDs) and/or light-emitting devices (e.g., an array of LEDs); in one embodiment, each of the elements and hands is formed, at least in part, by an array of display devices under control of a processor, such as described in connection with FIG. 5A and FIG. 5B.

In FIG. 23A, hour hand 150(12), minute hand 160(12) and third hand 190(10) indicate a time of 10:11:30. FIG. 23A also shows a cursor 899. A user of clock display 114 uses a pointing device (e.g., a computer mouse, a stylus or the user's hand on a touch screen) to position cursor 899 over a location of clock display 114 that corresponds to a desired time input. For example, FIG. 23A shows cursor 800 positioned over circular timing element 110(15). The user selects the location of the cursor, e.g., by clicking the mouse or pressing an “Enter” button with a stylus or finger. Once the user selects the location of the cursor, clock display 110(14) updates the displayed time correspondingly. For example, in FIG. 23B, hour hand 150(12), minute hand 160(12) and third hand 190(10) indicate a time of 7:11:30, hour hand 150(12) having moved to indicate the timing element selected by cursor 800 in FIG. 23A.

The time increments that may be input by a user of a clock display may vary. For example, clock display 100(15) includes twelve five-minute increment timing elements 120(85)-120(96) and sixty circular timing elements 180(349)-180(408). In one embodiment, a user may click on one of five-minute increment timing elements 120(85)-120(96) to input a five-minute increment of time, that is, to input time with an accuracy of five minutes. Certain embodiments may provide a way to use circular timing elements 180(349)-180(408) to facilitate input of either minutes or seconds. For example, in one embodiment, a single mouse click on one of circular timing elements 180(349)-180(408) may indicate a time input of minutes while a double mouse click may indicate a time input of seconds, or vice versa. In another embodiment, a left mouse click may indicate minutes while a right click may indicate seconds, or vice versa. Alternatively, a user may “drag and drop” hands to set time (e.g., the user may place cursor 899 over hand 150(12), depress and hold a mouse button, move cursor 899 to one of elements 110(109)-110(120) that corresponds to a desired time, and release the mouse button). Time set in this manner may include a current time, an alarm time, a reminder time, a time for a meeting, and/or a recipe time (e.g., a time to start or stop a cooking sequence), for example.

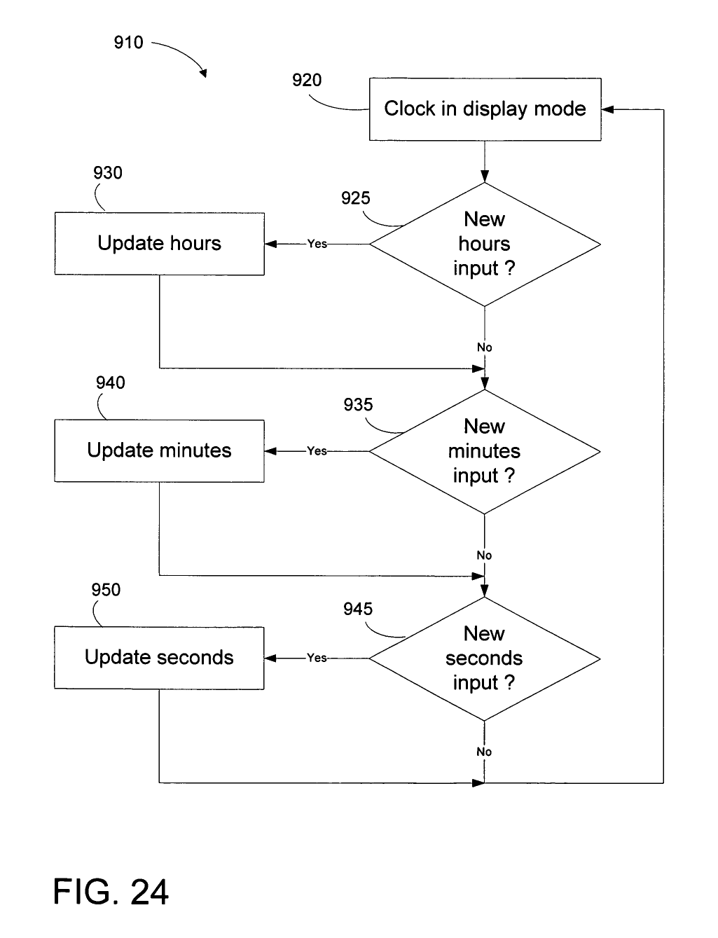

FIG. 24 is a flowchart of an embodiment of a time input process 810. Process 810 may be implemented for example by a processor, under the control of software, a clock display (e.g., clock display 100(15)), and pointing and/or input devices (e.g., a computer mouse, a stylus, a touch screen, and/or buttons). In step 820, the clock is in a display mode, i.e., the clock is displaying a time of day. In step 825, the processor checks to see whether a new hour input has been provided (e.g., by clicking on one of circular timing elements 110(109)-110(120) of clock display 100(15), or by an input device while pointing to one of circular timing elements 110(109)-110(120)). If so, the processor updates the hours indicated on the clock display in step 830. In step 835, the processor checks to see whether a new minute input has been provided (e.g., by clicking on, or pointing to, one of circular timing elements 120(109)-110(120), or circular timing elements 180(349)-180(408) of clock display 100(15), as discussed above). If so, the processor updates the minutes indicated on the clock display in step 840. In step 845, the processor checks to see whether a new second input has been provided (e.g., by clicking on, or pointing to, one of circular timing elements 180(349)-180(408) of clock display 100(15), as discussed above). If so, the processor updates the seconds indicated on the clock display in step 850. After checking steps 825, 835 and 845 and the corresponding updating steps if required, process 810 returns to step 820.

Certain changes may be made in the information displays described herein without departing from the scope hereof. For example, a clock designer may choose other combinations of circular elements, segments thereof and locating elements; other techniques for distinguishing an activated element from one that is not activated may be implemented. A circular element that starts with a central point or spot and “fills” from that region by activating annular rings, proceeding outward from the central point or spot to a boundary of the circular element, may be used to indicate time or other quantities (e.g., percentage of a total). Alternatively, a circular element may begin as “filled” and deactivate annular rings until it is “empty.” Additionally, information displays described herein may be implemented in or on objects; for example, as a stand-alone clock, as a watch, as part of another object (e.g., a piece of furniture, a building, a sign or a household appliance), or within displays such as television screens or computer displays. Information displays described herein may be implemented within clock faces, for example, that are round, oval, square, rectangular, hexagonal or other shape. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An information display, comprising:
at least twenty-four timing elements, a first twelve of the timing elements being arranged in a first circle about a center, each of the first twelve elements overlapping another of the first twelve elements and being overlapped by another of the first twelve elements;
a second twelve of the timing elements being arranged in a second circle, the second circle being larger than the first circle, each of the second twelve elements being tangential to one of the first twelve elements;
an hour hand having a first encircling element that positions over one of the first twelve timing elements, to indicate an hour; and
a minute hand having a second encircling element that positions over one of the second twelve timing elements, to indicate a five minute increment.

2. The information display of claim 1, the hour hand comprising a blocking element configured such that when the first encircling element positions over one of the first twelve timing elements, to indicate an hour, the blocking element inhibits viewing of an overlapping one of the first twelve timing elements.

3. The information display of claim 1, comprising forty-eight additional timing elements, such that the minute hand positions over one of the second twelve timing elements or one of the forty-eight additional timing elements, to indicate a minute.

4. The information display of claim 1, further comprising sixty additional timing elements arranged in a third circle, the third circle being larger than the second circle, the minute hand comprising a third encircling element that positions over one of the sixty additional timing elements, to indicate a minute.

5. The information display of claim 4, further comprising a third hand, the third hand comprising a fourth encircling element that positions over one of the sixty additional timing elements, to indicate a second.

6. The information display of claim 1, the minute hand comprising a transparent portion, wherein features of the information display are visible through the transparent portion.

7. The information display of claim 1, the hour hand comprising a first disk, the first disk comprising the first encircling element, the minute hand comprising a second disk, the second disk comprising the second encircling element.

8. The information display of claim 1, wherein each of the twenty-four timing elements is circular in shape.

9. The information display of claim 8, further comprising a central timing element, the central timing element being smaller than the first circle, each of the twenty-four timing elements having substantially equal diameters, each of the first twelve timing elements being tangential to the central timing element.

10. The information display of claim 1, wherein each of the twenty-four timing elements forms one of an oval, a hexagon, a wedge and a square.

11. The information display of claim 1, wherein the information display within a clock faces that is one of round, oval, square, rectangular and hexagonal.

12. The information display of claim 1, the first twelve elements having associated numerals 1, 2, 3, 4, 5, 6, 7, 8, 9, 10, 11 and 12 to indicate the hour.

13. The information display of claim 1, the second twelve elements having associated numerals 5, 10, 15, 20, 25, 30, 35, 40, 45, 50, 55 and 60 to indicate five minute increments.

14. The information display of claim 1, further comprising a timekeeping mechanism to drive the minute hand and the hour hand.

15. The information display of claim 14, the timekeeping mechanism being operable to move the minute hand in six degree increments such that the minute hand jumps after each minute.

16. The information display of claim 14, the timekeeping mechanism being operable to move the hour hand in thirty degree increments such that the hour hand jumps after each hour.

17. The information display of claim 1, further comprising a processor configured to activate display devices to form the timing elements.

18. The information display of claim 17, the processor configured to activate display devices to form numerals associated with any of the timing elements.

19. The information display of claim 17, the processor being configured to activate display devices to form the hour hand and the minute hand.

20. The information display of claim 17, the processor being configured to select at least one of the timing elements, to form a contrasting appearance with respect to non-selected elements, to indicate time.

21. An information display, comprising:
twelve timing elements arranged in a first circle about a center, each of the first twelve timing elements overlapping another of the first twelve timing elements and being overlapped by another of the first twelve timing elements;
sixty timing elements arranged in a plurality of groups,
each of the plurality of groups having two, three, four, five, six, ten, fifteen, twenty or thirty timing elements and disposed in a spiral pattern, such that each of the sixty timing elements is located at a six degree angular offset, relative to the center, from two other of the sixty timing elements;
an hour hand comprising a first encircling element that positions over one of the twelve timing elements, to indicate an hour, and
a minute hand comprising a second encircling element that positions over one of the sixty timing elements, to indicate a minute.

22. A calendar display, comprising
twelve month timing elements;
thirty-one day-of-month timing elements;
a month hand having a first encircling element that is positionable over each one of the month timing elements, to indicate a month; and
a day-of-month hand having a second encircling element that is positionable over each one of the day-of-month timing elements, to indicate a day of a month.

23. The calendar display of claim 22, further comprising seven day-of-week elements and a day-of-week hand comprising a third encircling element that is positionable over each one of the day-of-week timing elements, to indicate a day of a week.

24. An information display comprising a plurality of overlapping display elements, wherein a subset of the elements have a selected appearance, and the elements not in the subset have a non-selected appearance, such that the elements with the selected appearance indicate a number within a predetermined range.

25. The information display of claim 24, wherein the elements are formed by display elements controlled by a processor.

26. A speedometer display, comprising:
a plurality of display elements forming coarse speed elements and arranged in a first arc such that, except display elements at ends of the first arc, each coarse speed element overlaps another of the display elements and is overlapped by another of the display elements;
a plurality of display elements forming fine speed elements and arranged in a second arc that is adjacent to the first arc; and
a pivoting pointing element having an encircling element, for indicating a coarse speed number by pivoting the encircling element over one of the coarse speed elements.

27. The speedometer display of claim 26, the pointing element further comprising a tip for indicating a precise speed number by pivoting the tip over one of the fine speed elements.

28. A method of setting a time in a clock display having timing elements, comprising
activating individual display devices of an array of display devices to form a plurality of timing elements, each of the timing elements corresponding to a time value; and
responding to a pointing device that points to one of the timing elements to set time of the clock display.

29. The method of claim 28, the step of pointing comprising utilizing a mouse, a stylus or touch screen.

30. The method of claim 28, wherein the time is one of a current time, an alarm time, a reminder time, a meeting time and a recipe time.

31. A software product comprising instructions, stored on computer-readable media, wherein the instructions, when executed by a processor, perform steps for setting time of a clock display, the instructions comprising:
instructions for activating individual display devices of an array of display devices to form a plurality of timing elements, each of the timing elements corresponding to a time value; and
instructions for responding to a pointing device that points to one of the timing elements to set time of the clock display.

32. An information display comprising timing elements and two or more hands, at least one of the hands comprising an encircling element, wherein the information display indicates time by positioning the encircling element over one of the timing elements.

33. A software product comprising instructions, stored on computer-readable media, wherein the instructions, when executed by a processor, perform steps for showing time, the instructions comprising:
instructions for forming at least twenty-four timing elements, a first twelve of the timing elements being arranged in a first circle about a center, each of the first twelve elements overlapping another of the first twelve elements and being overlapped by another of the first twelve elements, a second twelve of the timing elements being arranged in a second circle, the second circle being larger than the first circle, each of the second twelve elements being tangential to one of the first twelve elements;
instructions for forming an hour hand having a first encircling element that positions over one of the first twelve timing elements, to indicate an hour; and
instructions for forming a minute hand having a second encircling element that positions over one of the second twelve timing elements, to indicate a five minute increment.

34. A method for indicating time, comprising:
providing a plurality of time numerals on a clock face, each of the time numerals being oriented outwardly from a center of the clock face; and
rotating at least one hand having at least one encircling element about the center, to position the encircling element over at least one of the time numerals to indicate the time.

35. The method of claim 34, further comprising providing a blocking element with the hand, wherein the step of rotating comprises positioning the blocking element to inhibit full or partial viewing of at least one other numeral not used to indicate the time.
